(19) United States
(12) Patent Application Publication
(10) Pub. No.: US 2026/0140023 A1
(43) Pub. Date: May 21, 2026

(54) LABORATORY SYSTEM AND METHOD FOR SAMPLING REACTOR CONTENTS

(71) Applicant: TCS Patent B.V., Alkmaar (NL)

(72) Inventors: Stephan Olivier Banning, Santpoort Noord (NL); Serge Peter Sonneborn, Heiloo (NL); Joel Michael Hawkins, Groton, CT (US); David Michael Pfisterer, Groton, CT (US)

(21) Appl. No.: 19/119,458

(22) PCT Filed: Oct. 12, 2023
(86) PCT No.: PCT/EP2023/078412

§ 371 Date: Apr. 9, 2025

(30) Foreign Application Priority Data
Oct. 13, 2022 (NL) 2033299

(51) Int. Cl. G01N 1/34; G01N 35/10

(52) U.S. Cl. CPC G01N 1/34; G01N 35/10; G01N 2035/1027; G01N 2035/1053

(57) ABSTRACT

A method of sampling a reaction liquid from a reactor includes: bringing the sampling fluid connection in fluid communication with the secondary fluid channel entrance to form a first flow path extending from the sampling fluid connection to the secondary fluid channel entrance and drawing a sample into the sample channel by injecting sampling fluid into the reactor via the first flow path and the secondary fluid channel entrance while sealing the buffer volume of the sample channel from the secondary fluid connection and the offgas connection, and bringing the secondary fluid connection in fluid communication with the sample extraction outlet, thereby forming a second flow path extending from the secondary fluid connection to the sample extraction outlet and subsequently feeding a secondary fluid to the secondary fluid connection, thereby extracting the sample from the sample channel and moving it to a suitable destination.

### CROSS-REFERENCE TO RELATED APPLICATIONS

This application is the National Stage of International Application No. PCT/EP2023/078412, filed Oct. 12, 2023, which claims the benefit of Netherlands Application No. 2033299, filed Oct. 13, 2022, the contents of which is incorporated by reference herein.

### FIELD OF THE INVENTION

The present invention relates to laboratory systems and sample extraction devices and methods, in particular at least partially automated laboratory systems and sample extraction devices and methods.

### BACKGROUND OF THE INVENTION

In process chemistry and crystallization analysis in particular, many reactions are often performed in research. Taking samples from such reactions is a valuable tool to provide insight in reaction processes such as crystallization and/or process chemistry. In current systems such as manual or partially automated pipetting devices, sampling is a labor intensive and complex process, leading to significant cost and possibility of human error. Furthermore, current systems often require a relatively large sample to be taken.

### OBJECT OF THE INVENTION

It is an object of the invention to provide a device and method for sampling a reactor in an efficient manner. It is a further object of the invention to provide a device and method for sampling a reactor in an accurate and/or reproducible manner. It is a further object of the invention to provide a device and method for sampling a reactor in a less labor intensive manner.

### SUMMARY OF THE INVENTION

In order to achieve at least one of the objects, in a first aspect a sample extraction device is provided, the sample extraction device being configured for extracting a sample from a reactor, the sample extraction device comprising:
a sample channel configured to extend into a reactor volume of the reactor, the sample channel comprising a sample channel entrance configured to be arranged below a liquid level of a reaction liquid in the reactor volume,
a secondary fluid channel configured to extend into the reactor volume, the secondary fluid channel comprising a secondary fluid channel entrance configured to be in fluid communication with the reactor volume,
a sampling fluid connection connected to the sample channel, configured to provide a pressurised sampling fluid to sample extraction device via the
sampling fluid connection, wherein the sampling fluid is preferably an inert gas such as nitrogen gas,
a secondary fluid connection,
a sample extraction outlet,
an offgas connection,
a buffer volume arranged between the sampling valve and the sampling fluid connection,
a valving system connected to the sample channel, the secondary fluid channel, the sampling fluid connection, the secondary fluid connection, the sample extraction outlet, and the offgas connection,
   the valving system comprising a sampling valve,
   wherein:
the sampling valve is arranged between the sampling fluid connection and the sample channel entrance, the sampling valve comprises a sampling space with a cavity volume,
the sampling valve is movable to a sampling position and to a transportation position,
the sampling space is in fluid communication with the sample channel in the sampling position of the sampling valve, the sampling space is in fluid communication with the sample extraction outlet in the transportation position of the sampling valve.

The sample extraction device according to the invention allows sampling a reactor in an efficient manner, while minimizing the chance of operator error and providing a high repeatability accuracy. The valving system allows to form the required flow paths to perform various operations. The buffer volume prevents sampled fluid from passing too far into the system, reducing the risk of contamination.

In an embodiment, the valving system is arrangeable in a sampling configuration, wherein in the sampling configuration:
the sampling valve is in the sampling position,
the secondary fluid channel entrance is in fluid communication with the sampling fluid connection,
the sample channel entrance is not in fluid communication with the offgas connection.

In an embodiment, the valving system comprises a sample blocking valve arranged in the sample channel between the sampling valve and the sampling fluid connection, wherein the sample blocking valve is arranged in a blocking position in the sampling configuration of the valving system.

The sample blocking valve prevents sampled fluid from passing during sampling and/or causes a pressure in the sample channel to rise during sampling. The pressure in the buffer volume counters the pressure in the reactor volume. This aids in controlling the sampling procedure and the level of sampled fluid in the sample channel. The sample blocking valve may be in a passing position in situations other than during sampling and/or may be open in some situations other than during sampling.

In an embodiment, the buffer volume is arranged between the sampling valve and the sample blocking valve.

In an embodiment, the valving system is arrangeable in a depressurising configuration, wherein in the depressurising configuration:
the sampling valve is in the sampling position,
the secondary fluid channel entrance is in fluid communication with the offgas connection,
the sample channel entrance is in fluid communication with the offgas connection.

In an embodiment, the valving system is arrangeable in a transport configuration, wherein in the transport configuration:
the sampling valve is in the transportation position,
the secondary fluid connection is in fluid communication with the sampling space.

As the sampling space is in fluid communication with the secondary fluid connection, the secondary fluid connection can be used to provide a fluid to move the sample from the sampling space to a suitable location.

In an embodiment, in the transport configuration:
the sample extraction outlet is in fluid communication with the secondary fluid connection, AND/OR
the sample channel entrance is not in fluid communication with the sampling fluid connection.

As the sample extraction outlet is in fluid communication with the secondary fluid connection, the secondary fluid connection can be used to provide a fluid to move the sample from the sampling space to a suitable location via the sample extraction outlet.

In an embodiment:
the secondary fluid connection comprises a transportation fluid connection for providing a transportation fluid, wherein optionally the transportation fluid is an inert gas, preferably nitrogen gas,
in the transportation position of the sampling valve, the sampling space is in fluid communication with the transportation fluid connection.

In an embodiment, the sample extraction device comprises a cleaning fluid connection, wherein the valving system is arrangeable in a cleaning configuration, wherein optionally the cleaning fluid connection is the sampling fluid connection, wherein in the cleaning configuration:
a cleaning fluid connection is in fluid communication with the sample channel entrance,
the secondary fluid channel entrance is in fluid communication with the offgas connection.

In the cleaning configuration, fluid can be led from the cleaning fluid connection via the sample channel into the reactor to clean and/or purge the sample channel.

In an embodiment:
the secondary fluid connection comprises a quench fluid connection for providing a quench fluid,
in the transportation position of the sampling valve, the sampling space is in fluid communication with the quench fluid connection.

The quench fluid can stop one or more chemical reactions occurring in the sample.

In an embodiment,
the secondary fluid connection comprises a dilute fluid connection for providing a dilute fluid,
in the transportation position of the sampling valve, the sampling space is in fluid communication with the dilute fluid connection.

The dilute fluid can dilute the sample to make it suitable for analysis.

In an embodiment, the sampling valve is configured to be arranged above the liquid level of the reaction liquid in the reactor volume.

In an embodiment, the sample extraction device comprises the valving system comprises:
a secondary fluid valve arranged in the secondary fluid channel and between the secondary fluid connection and the secondary fluid channel entrance,
   wherein:
the secondary fluid valve is moveable to a secondary blocking position wherein the secondary fluid valve blocks flow through the secondary fluid channel such that flow through the secondary fluid channel entrance is blocked and the secondary fluid valve is moveable to a secondary flow position wherein the secondary fluid valve allows flow through the secondary fluid channel and allows flow through the secondary fluid channel entrance.

In a second aspect of the invention, a method of sampling a reaction liquid from a reaction is provided, the method comprising the steps of:
providing a sample extraction device comprising the features of the preceding embodiments,
bringing the sampling fluid connection in fluid communication with the secondary fluid channel entrance to form a first flow path extending from the sampling fluid connection to the secondary fluid channel entrance and drawing a sample into the sample channel by injecting sampling fluid into the reactor via the first flow path and the secondary fluid channel entrance while sealing the buffer volume of the sample channel from the secondary fluid connection and the offgas connection, thereby raising a level of reaction liquid in the sample channel, and raising a pressure in said buffer volume of the sample channel,
bringing the secondary fluid connection in fluid communication with the sample extraction outlet, thereby forming a second flow path extending from the secondary fluid connection to the sample extraction outlet and subsequently feeding a secondary fluid to the secondary fluid connection, thereby extracting the sample from the sample channel and moving it to a suitable destination.

As the buffer volume is sealed from the secondary fluid connection and the offgas connection during sampling, the pressure in the buffer volume will rise as sampling fluid is injected into the reactor and the level of the reaction liquid is raised in the sample channel. This rising pressure counteracts the pressure in the reactor that forces the reaction liquid in the sample channel. This way, the level of reaction liquid in the sample channel is controlled.

In an embodiment, the method comprises the steps of depressurising a volume in the sample channel, a volume in the secondary fluid channel and the reactor volume by arranging the valving system to bring the sample channel and the secondary fluid channel in fluid communication with the offgas connection, thereby forming a third flow path extending from the secondary fluid channel entrance to the offgas connection and a fourth flow path extending from the sample channel entrance to the offgas connection.

the depressurising step ensures that the pressures at points in the system is known and substantially equal to the pressure of the offgas connection. This allows accurate control of the system during sampling.

In an embodiment, the step of depressurising comprises arranging the valving system in the depressurising configuration.

In an embodiment, the method comprises the steps of cleaning the sample extraction device by:
injecting a cleaning fluid into the reactor volume from the sampling fluid connection via the sample channel, thereby blowing any reaction liquid out of the sample channel, wherein optionally the cleaning fluid is an inert gas such as nitrogen gas,
removing the cleaning fluid from the reactor volume via the secondary fluid channel and the secondary fluid connection,
wherein said steps of cleaning the sample extraction device are preferably performed before drawing a sample.

During cleaning, fluid is led via the sample channel into the reactor to clean and/or purge the sample channel. Furthermore, as reaction liquid is pushed out of the sample channel, a fresh, well mixed sample from the reactor can subsequently be taken instead of a sample which has already resided in the sample channel for a longer period.

In an embodiment, the steps of cleaning the sample extraction device comprise arranging the valving system in the cleaning configuration.

In an embodiment, the method comprises rinsing the sampling tube by performing the steps of:
injecting sampling fluid into the reactor volume via the secondary fluid channel entrance, thereby raising a level of reaction liquid in the sample channel,
subsequently removing fluid from the reactor volume via the secondary fluid channel entrance, thereby lowering the level of reaction liquid in the sample channel,
optionally repeating the steps of injecting and removing sampling fluid via the secondary fluid channel entrance,
   wherein said steps are preferably performed before depressurising and drawing a sample.

Injecting sampling fluid and subsequently removing fluid from the reactor via the secondary fluid channel entrance alternately raises and lowers the level of reaction liquid in the sample channel. This helps in cleaning the sample channel.

In an embodiment, the step of drawing the sample comprises arranging the valving system in the sampling configuration.

In an embodiment, the step of drawing the sample comprises the steps of:
injecting sampling fluid into the reactor volume via the sampling fluid connection, the valving system and the secondary fluid channel entrance, thereby forcing reaction liquid from the reactor volume into the sample channel into and past the sampling valve and into the buffer volume of the sample channel,
regulating an amount and/or pressure of sampling fluid injected into the reactor volume to control a level of the reaction liquid in the buffer volume.

By regulating an amount and/or pressure of sampling fluid injected into the reactor volume, the level of the reaction liquid in the buffer volume can be controlled. Preferably, the pressure of the sampling fluid is controlled such that it is similar to the expected backpressure caused by the sealing of the buffer volume when the reaction liquid is at the desired level in the buffer volume.

In an embodiment, the step of extracting the sample and moving it to a suitable location comprises arranging the valving system in the transport configuration.

In an embodiment, the secondary fluid comprises a quench fluid and/or a dilution fluid and/or a transportation fluid, the transportation fluid preferably being an inert gas such as nitrogen gas.

The quench fluid can stop one or more chemical reactions occurring in the sample. The dilute fluid can dilute the sample to make it suitable for analysis. The transportation fluid can be used alternatively or in addition to the quench fluid and/or the dilute fluid.

In a third aspect of the invention a laboratory system is provided, comprising:
at least one reactor,
a sample extraction device for extracting a sample from the at least one reactor into a sampling space,
a fluid supply system comprising a transportation fluid supply,
at least one sample storage container,
at least one fluid supply channel connecting the extraction device to the fluid supply system,
at least one sample extraction channel connecting the extraction device to the sample storage container,
   wherein the fluid supply system is arranged to push the sample from the sampling space through the sample extraction channel to the at least one sample storage container using transportation fluid of the transportation fluid supply.

The system according to the invention allows sampling a reactor in an efficient manner, while minimizing the chance of operator error and providing a high repeatability accuracy. The sample extraction device may be any sample extraction device, for example a sample extraction device according to one of the first, fifth, seventh or eleventh aspects.

In an embodiment of the laboratory system, the laboratory system comprises:
multiple sample storage containers,
a container selection system to associate the at least one sample extraction channel with one of the multiple sample storage containers.

In an embodiment of the laboratory system:
the laboratory system comprises multiple reactors,
the sample extraction device cooperates with each of the multiple reactors via a downstream reactor selection system for extracting a sample from a selected reactor into the sampling space,
the at least one fluid supply channel connects the fluid supply system to the sample extraction device, and
the at least one sample extraction channel connects the sample extraction device to the at least one sample storage container.

In an embodiment of the laboratory system, the laboratory system comprises N reactors, wherein the downstream reactor selection system comprises a downstream N-way valve configured for bringing the sample extraction device in fluid communication with one of the N reactors. The downstream N-way valve comprises one inlet and N outlets, yielding a total of N+1 fluid connections.

In an embodiment of the laboratory system:
the laboratory system comprises multiple reactors and multiple sample extraction devices,
each sample extraction device has a sampling space and each sample extraction device cooperates with one of the multiple reactors for extracting a sample from the at least one reactor into the respective sampling space,
the at least one fluid supply channel connects the fluid supply system to each sample extraction device, and
the at least one sample extraction channel connects each sample extraction device to the at least one sample storage container.

In an embodiment of the laboratory system, the laboratory system comprises N reactors, the laboratory system comprising an upstream reactor selection system configured for bringing the sample extraction device of one of the N reactors in fluid communication with the fluid supply system. The upstream N-way valve comprises one inlet and N outlets, yielding a total of N+1 fluid connections.

In an embodiment of the laboratory system, the upstream reactor selection system comprises an upstream N-way valve arranged in the fluid supply channel.

In an embodiment of the laboratory system, the at least one reactor is a thermal cycle reactor.

In an embodiment of the laboratory system, the fluid supply system comprises a quench fluid supply.

In an embodiment of the laboratory system, the fluid supply system is arranged to push quench fluid from the quench fluid supply through the fluid supply channel, the sampling space and/or the sample extraction channel using transportation fluid of the transportation fluid supply.

In an embodiment of the laboratory system, the fluid supply system comprises a dilution fluid supply.

In an embodiment of the laboratory system, the fluid supply system is arranged to push dilution fluid from the dilution fluid supply through the fluid supply channel, the sampling space and/or the sample extraction channel using transportation fluid of the transportation fluid supply.

In an embodiment of the laboratory system, the fluid supply system comprises a rinsing fluid supply.

In an embodiment of the laboratory system, the fluid supply system is arranged to push rinsing fluid from the rinsing fluid supply through the fluid supply channel, the sampling space and/or the sample extraction channel using transportation fluid of the transportation fluid supply.

In an embodiment of the laboratory system, the sample extraction device comprises:
a sample channel configured to extend into a reactor volume of the reactor, the sample channel comprising a sample channel entrance configured to be arranged below a liquid level of a reaction liquid in the reactor volume of the reactor,
a sampling valve arranged in the sample channel and comprising the sampling space, wherein the sampling valve is movable between a sampling position and a transportation position,
a secondary fluid channel configured to extend into a reactor volume of the reactor, the secondary fluid channel comprising a secondary fluid channel entrance,
   wherein, in the sampling position of the sampling valve, the sampling space is in fluid communication with the sample channel and wherein, in the transportation position of the sampling valve, the sampling space is in fluid communication with the at least one fluid supply channel and the at least one sample extraction channel.

In an embodiment of the laboratory system, the secondary fluid channel is connectable to the transportation fluid supply.

In a fourth aspect, the invention provides a method of sampling using a laboratory system according to any of the embodiments of the third aspect, the method comprising the steps of:
extracting a sample from the reactor into the sampling space,
transporting the sample to the sample storage container via the sample extraction channel by supplying the transportation fluid to the sampling space via the fluid supply channel.

In an embodiment of the method of sampling, the method comprises the step of supplying a quench fluid from the quench fluid supply to the sample.

In an embodiment of the method of sampling, the quench fluid is supplied to the sample via the fluid supply channel.

In an embodiment of the method of sampling, the quench fluid is supplied to the sample in the sample storage container.

In an embodiment of the method of sampling, the step of supplying the quench fluid comprises pushing the quench fluid through the fluid supply channel, the sampling space and/or the sample extraction channel using transportation fluid of the transportation fluid supply.

In an embodiment of the method of sampling, the method comprises the step of supplying a dilution fluid to the sample.

In an embodiment of the method of sampling, the dilution fluid is supplied to the sample via the fluid supply channel.

In an embodiment of the method of sampling, the dilution fluid is supplied to the sample in the sample storage container.

In an embodiment of the method of sampling, the step of supplying the dilution fluid comprises pushing the dilution fluid through the fluid supply channel, the sampling space and/or the sample extraction channel using transportation fluid of the transportation fluid supply.

In an embodiment of the method of sampling, the method comprises a rinsing step of rinsing the fluid supply channel by supplying a rinsing fluid from a rinsing fluid supply to the fluid supply channel and depositing the rinsing fluid in a waste container.

In an embodiment of the method of sampling, the rinsing step further comprises rinsing the sampling space and/or the at least one sample extraction channel by supplying the rinsing fluid to the sampling space and/or the at least one sample extraction channel from the fluid supply channel.

In an embodiment of the method of sampling, the step of supplying the rinsing fluid comprises pushing the rinsing fluid through the fluid supply channel, the sampling space and/or the sample extraction channel using transportation fluid of the transportation fluid supply.

In an embodiment of the method of sampling, the sample is extracted from the reactor into the sampling space by injecting the transportation fluid into the reactor volume via the secondary fluid channel.

In an embodiment of the method of sampling, the method comprises the step of registering a sample trigger to initiate sampling. The sample trigger may comprise a timestamp, a temperature measurement falling within or outside a certain range, a measurement of a reactor process parameter such as a crystallization parameter, a transmissivity measurement, a user input, or any other trigger. Measurements in order to determine the sample trigger may be performed by an analytics system comprising a Raman spectrometer and/or a camera monitoring the reactor. Timestamped data from the analytics system can then be compared with timestamped sample analysis data, for example data acquired by high-performance liquid chromatography or any other offline analysis of the samples, in order to achieve a comprehensive dataset of the reactor processes.

In a fifth aspect, the invention provides a sample extraction device configured for extracting a sample from a reactor, the sample extraction device comprising:
a sample extraction outlet,
a sample channel configured to extend into a reactor volume of the reactor, the sample channel comprising a sample channel entrance configured to be arranged below a liquid level of
a reaction liquid in the reactor volume of the reactor,
a sampling valve arranged in the sample channel,
a secondary fluid channel configured to extend into a reactor volume of the reactor, the secondary fluid channel comprising a secondary fluid channel entrance,
   wherein:
the sampling valve comprises a sampling space with a cavity volume,
the sampling valve is movable between a sampling position and a transportation position, wherein the sampling space is in fluid communication with the sample channel in the sampling position of the sampling valve and wherein the sampling space is in fluid communication with the sample extraction outlet in the transportation position of the sampling valve.

The sample extraction device according to the invention allows extraction of a sample from a reactor in an efficient manner, while minimizing the chance of operator error and providing a high repeatability accuracy.

In a sixth aspect, the invention provides a method of sampling a reaction liquid from a reactor using a sample extraction device according to the previous embodiment, the method comprising the steps of:
arranging the sampling valve in the sampling position,
filling the sampling space with a sampling volume of reaction liquid via the sample channel, the sampling volume being equal to the cavity volume,
subsequently arranging the sampling valve in the transportation position,
transporting the sampling volume of reaction liquid from the sampling space through the sample extraction outlet to a suitable destination.

In an embodiment of the method of sampling, the step of filling the sampling space is performed by applying a pressure differential between the reactor volume and the sampling space.

In an embodiment of the method of sampling, the pressure differential is achieved by introducing fluid into the reactor volume via the secondary fluid channel at a pressure above the pressure in the sampling space, thereby forcing the reaction liquid into the sampling space through the sample channel.

In a seventh aspect, the invention provides a sample extraction device configured for extracting a sample from a reactor, the sample extraction device comprising:
a sample channel configured to extend into a reactor volume of the reactor, the sample channel comprising a sample channel entrance configured to be arranged below a liquid level of a reaction liquid in the reactor volume,
a secondary fluid channel configured to extend into the reactor volume, the secondary fluid channel comprising a secondary fluid channel entrance configured to be in fluid communication with the reactor volume,
a sampling fluid connection connected to the sample channel, configured to provide a pressurised sampling fluid to the sampling fluid connection, wherein the sampling fluid is preferably an inert gas such as nitrogen gas,
a secondary fluid connection connected to the secondary fluid channel,
a sampling three way valve arranged in the sample channel, the sampling three way valve comprising a first sampling connection, a second sampling connection and a third sampling connection, wherein the first sampling connection and the second sampling connection are connected inline with the sampling channel and wherein the third sampling connection is connected to a sampling crossover tube which is connected with the secondary fluid channel at a secondary crossover connection, wherein the first sampling connection is arranged between the second sampling connection and the sampling fluid connection and the second sampling connection is arranged between the first sampling connection and the sample channel entrance,
   wherein:
the sampling three way valve is arranged between the sampling fluid connection and the sample channel entrance,
the sampling three way valve is movable to a sampling inline passing position wherein fluid flow is allowed between the first sampling connection and the second sampling connection and wherein no fluid flow is allowed through the third sampling connection,
the sampling three way valve is movable to a first sampling crossover position wherein fluid flow is allowed between the first sampling connection and the third sampling connection and wherein no fluid flow is allowed through the second sampling connection.

This sample extraction device allows efficient, accurate, and highly repeatable sampling of a reaction liquid from a reactor.

In an embodiment of the sample extraction device, the secondary fluid channel entrance is configured to be positioned above the liquid level of the reaction liquid in the reactor volume.

In an embodiment of the sample extraction device, the sample extraction device is incorporated in a cap which can be attached to standard format reactor vessels.

In an embodiment of the sample extraction device, Optionally, the sample extraction device can be connected with ports on a laboratory system chassis without external tubing, for example via a click-connect system.

In an embodiment of the sample extraction device, the sample extraction device comprises:
a sampling valve arranged in the sample channel,
a sample extraction outlet,
   wherein:
the sampling valve is arranged between the sampling fluid connection and the sample channel entrance, wherein the sampling valve is preferably arranged between the sampling three way valve and the sample channel entrance,
the sampling valve comprises a sampling space with a cavity volume,
the sampling valve is movable to a sampling position and to a transportation position,
the sampling space is in fluid communication with the sample channel in the sampling position of the sampling valve,
the sampling space is in fluid communication with the sample extraction outlet in the transportation position of the sampling valve.

In an embodiment of the sample extraction device, the sample extraction device comprises:
a transportation fluid connection for providing a transportation fluid, wherein optionally the transportation fluid is an inert gas, preferably nitrogen gas,
in the transportation position of the sampling valve, the sampling space is in fluid communication with the transportation fluid connection in the transportation position of the sampling valve.

In an embodiment of the sample extraction device, the sampling valve is configured to be arranged above the liquid level of the reaction liquid in the reactor volume.

In an embodiment of the sample extraction device, the sample channel comprises a buffer volume arranged between the sampling valve and the sampling fluid connection, wherein the buffer volume is preferably arranged between the sampling valve and the sampling three way valve.

In an embodiment of the sample extraction device, the sample extraction device comprises:
a secondary fluid valve arranged in the secondary fluid channel and between the secondary fluid connection and the secondary fluid channel entrance, wherein the secondary fluid valve is preferably arranged between the secondary crossover connection and the secondary fluid channel entrance,
   wherein:
the secondary fluid valve is moveable to a secondary blocking position wherein the secondary fluid valve blocks flow through the secondary fluid channel and the secondary fluid valve is moveable to a secondary flow position wherein the secondary fluid valve allows flow through the secondary fluid channel.

In an embodiment of the sample extraction device, the sample extraction device comprises:
a secondary three way valve arranged in the secondary fluid channel, the secondary three way valve comprising a first secondary connection, a second secondary connection and a third secondary connection, wherein the first secondary connection and the second secondary connection are connected inline with the secondary fluid channel and wherein the third secondary connection is connected to a secondary crossover tube which is connected with the sample channel at a sampling crossover connection, wherein the first secondary fluid connection is arranged between the second secondary fluid connection and the secondary fluid connection and the second secondary fluid connection is arranged between the first secondary fluid connection and the secondary fluid channel entrance,
   wherein:
the secondary three way valve is arranged between the secondary fluid connection and the secondary fluid channel entrance, wherein the secondary three way valve is preferably arranged between the secondary fluid connection and the secondary crossover connection,
the secondary three way valve is movable to a secondary inline passing position wherein fluid flow is allowed between the first secondary connection and the second secondary connection and wherein no fluid flow is allowed through the third secondary connection,
the secondary three way valve is movable to a first secondary crossover position wherein fluid flow is allowed between the first secondary connection and the third secondary connection and wherein no fluid flow is allowed through the second secondary connection.

In an embodiment of the sample extraction device:
the secondary crossover connection is arranged between the secondary three way valve and the secondary fluid valve.

In an embodiment of the sample extraction device:
the sampling crossover connection is arranged between the sampling three way valve and the sampling valve.

In an embodiment of the sample extraction device, the sample extraction device comprises:
a sampling two way valve arranged in the sample channel between the sampling fluid connection and the sampling three way valve, wherein the sampling two way valve is movable to a sampling open position allowing flow past the sampling two way valve and a sampling closed position not allowing flow past the sampling two way valve, AND/OR
a secondary two way valve arranged in the secondary fluid channel between the secondary fluid connection and the secondary three way valve, wherein the secondary two way valve is movable to a secondary open position allowing flow past the secondary two way valve and a secondary closed position not allowing flow past the secondary two way valve.

In an eighth aspect, the invention provides a method of sampling a reaction liquid from a reactor using a sample extraction device, the sample extraction device comprising:
a sample channel configured to extend into a reactor volume of the reactor, the sample channel comprising a sample channel entrance configured to be arranged below a liquid level of a reaction liquid in the reactor volume,
a secondary fluid channel configured to extend into the reactor volume, the secondary fluid channel comprising a secondary fluid channel entrance configured to be in fluid communication with the reactor volume,
a sampling fluid connection connected to the sample channel, configured to provide a pressurised sampling fluid to the sampling fluid connection, wherein the sampling fluid is preferably an inert gas such as nitrogen gas,
a secondary fluid connection connected to the secondary fluid channel,
   wherein the method comprises the steps of:
depressurising a volume in the sample channel, a volume in the secondary fluid channel and the reactor volume by bringing the sample channel and the secondary fluid channel in fluid communication with an offgas area such as the atmosphere, drawing a sample into the sample channel by injecting sampling fluid into the reactor via the secondary fluid channel entrance while sealing a volume of the sample channel from the sampling fluid connection and the secondary fluid connection, thereby raising a level of reaction liquid in the sample channel, and raising a pressure in said volume of the sample channel,
extracting the sample from the sample channel and moving it to a suitable destination.

In an embodiment of the method of sampling, the method comprises the steps of:
injecting a cleaning fluid into the reactor volume from the sampling fluid connection via the sample channel, thereby blowing any reaction liquid out of the sample channel, wherein optionally the cleaning fluid is an inert gas such as nitrogen gas,
removing the cleaning fluid from the reactor volume via the secondary fluid channel and the secondary fluid connection,
   wherein said steps are preferably performed before depressurising and drawing a sample.

In an embodiment of the method of sampling, the method comprises the steps of:
injecting sampling fluid into the reactor volume via the secondary fluid channel entrance, thereby raising a level of reaction liquid in the sample channel,
subsequently removing fluid from the reactor volume via the secondary fluid channel entrance, thereby lowering the level of reaction liquid in the sample channel,
   wherein said steps are preferably performed before depressurising and drawing a sample.

In an embodiment, the method comprises the steps of:
arranging the sampling three way valve in the first sampling crossover position,
injecting sampling fluid into the reactor volume via the sampling fluid connection, the sampling three way valve and the secondary fluid channel entrance, thereby raising a level of reaction liquid in the sample channel,
subsequently removing fluid from the reactor volume via the sampling fluid connection, the sampling three way valve and the secondary fluid channel entrance, thereby lowering the level of reaction liquid in the sample channel.

Instead of using sampling fluid, a different fluid may be used for rinsing the sample extraction device.

In an embodiment, the method comprising the steps of:
closing the sampling fluid connection and opening the secondary fluid connection,
arranging the sampling three way valve in the first sampling crossover position,
alternatingly arranging the secondary three way valve in the secondary inline passing position and the first secondary crossover position multiple times to equalise the pressure in both the reactor volume and the sample channel with the pressure of the secondary fluid connection.

In an embodiment of the method of depressurizing, the step of depressurising the sample extraction device is performed prior to taking a sample from the reactor.

In an embodiment of the method of depressurizing, the method comprises the step of arranging the sampling valve in the sampling position.

In an embodiment of the method of depressurizing, the method comprises the step of arranging the secondary fluid valve in the secondary flow position.

In an embodiment, the method comprises the steps of:
arranging the sampling three way valve in the first sampling crossover position,
arranging the sampling valve in the sampling position,
closing the secondary fluid connection,
injecting sampling fluid into the reactor volume via the sampling fluid connection, the sampling three way valve and the secondary fluid channel entrance, thereby forcing reaction liquid from the reactor volume into the sample channel and into the sampling space, thereby filling the sampling space with a sampling volume of reaction liquid, the sampling volume being equal to the cavity volume,
subsequently arranging the sampling valve in the transportation position,
transporting the sampling volume of reaction liquid from the sampling space through the sample extraction outlet to a suitable destination.

In an embodiment of the method of sampling, a volume in the sample channel is sealed from the sampling fluid connection and the secondary fluid connection during the injection of sampling fluid into the reactor volume, such that a pressure in said volume of the sample channel is raised by forcing reaction liquid from the reactor volume into the sample channel.

In an embodiment of the method of sampling, the method comprises the steps of:
arranging the sampling three way valve in the first sampling crossover position,
injecting sampling fluid into the reactor volume via the sampling fluid connection, the sampling three way valve and the secondary fluid channel entrance, thereby forcing reaction liquid from the reactor volume into the sample channel into and past the sampling valve and into the buffer volume,
regulating an amount and/or pressure of sampling fluid injected into the reactor volume to control a level of the reaction liquid in the buffer volume.

In an embodiment of the method of sampling, the method comprises the step of:
preventing the reaction liquid forced into the sample channel from reaching the sampling three way valve by regulating an amount and/or pressure of sampling fluid injected into the reactor volume to control a level of the reaction liquid in the buffer volume.

In an embodiment of the method of sampling, a pressure of the sampling fluid is controlled to raise the sample in the sample channel completely through the sampling valve, without undercharging the sampling valve or overshooting the sampling valve contaminating the system. Optionally, the volume past the sampling valve when seen from the reactor volume is sealed from any volume via any path other than through the sampling valve.

In an embodiment of the method of sampling, a pressure and volume of sampling fluid injected into the reactor volume are chosen so that the sample completely fills the sampling valve, without undercharging the sampling valve or overshooting the sampling valve contaminating the system, across a desired range of density, viscosity, and amounts of the reaction liquid.

In an embodiment of the method of sampling, the method comprises performing the step of:
arranging the secondary fluid valve in the secondary flow position, before injecting sampling fluid into the reactor volume.

In an embodiment of the method of sampling, the method comprises the step of:
arranging the secondary fluid valve in the secondary blocking position after filling the sampling space with a sampling volume of reaction liquid.

In an embodiment, the method comprises the steps of, prior to taking the sample from the reactor:
arranging the sampling three way valve in the sampling inline passing position,
arranging the secondary three way valve in the secondary inline passing position,
injecting a cleaning fluid into the reactor volume from the sampling fluid connection via the sample channel, thereby blowing any reaction liquid out of the sample channel, wherein optionally the cleaning fluid is an inert gas such as nitrogen gas,
removing the cleaning fluid from the reactor volume via the secondary fluid channel and the secondary fluid connection.

In a ninth aspect, the invention provides a method of sampling a reaction liquid according to any of the preceding embodiments of any of the method aspects, i.e. of the sixth or eighth aspect, wherein the method is performed using a device or system according to any of the third, fourth, fifth, or seventh aspects.

In a tenth aspect, the invention provides a method of sampling a reaction liquid combining the steps of at least two of any of the preceding embodiments of any of the method aspects, i.e. any of the sixth, eighth, or ninth aspects.

In an eleventh aspect, the invention provides a sample extraction device configured for extracting a sample from a reactor, the sample extraction device comprising:
a sample channel configured to extend into a reactor volume of the reactor, the sample channel comprising a sample channel entrance configured to be arranged below a liquid level of a reaction liquid in the reactor volume,
a secondary fluid channel configured to extend into the reactor volume, the secondary fluid channel comprising a secondary fluid channel entrance configured to be in fluid communication with the reactor volume,
a sampling fluid connection connected to the sample channel, configured to provide a pressurised sampling fluid to the sampling fluid connection, wherein the sampling fluid is preferably an inert gas such as nitrogen gas,
a secondary fluid connection connected to the secondary fluid channel,
a multiway valve, wherein the multiway valve is connected inline with the sample channel via a first multiway connection and a second multiway connection, wherein the multiway valve is connected inline with the secondary fluid channel via a third multiway connection and a fourth multiway connection,
   wherein:
the first multiway connection is arranged between the second multiway connection and the sampling fluid connection, the second multiway connection is arranged between the first multiway connection and the sample channel entrance, the third multiway connection is arranged between the fourth multiway connection and the secondary fluid connection, the fourth multiway connection is arranged between the third multiway connection and the secondary fluid channel entrance,
   the multiway valve is configurable to connect any one of the four multiway connections with one or more of the other multiway connections.

In an embodiment of the sample extraction device, the sample extraction device comprises:
a sampling valve arranged in the sample channel,
a sample extraction outlet,
   wherein:
the sampling valve is arranged between the sampling fluid connection and the sample channel entrance, wherein the sampling valve is preferably arranged between the multiway valve and the sample channel entrance,
the sampling valve comprises a sampling space with a cavity volume,
the sampling valve is movable to a sampling position and to a transportation position,
the sampling space is in fluid communication with the sample channel in the sampling position of the sampling valve,
the sampling space is in fluid communication with the sample extraction outlet in the transportation position of the sampling valve.

In an embodiment of the sample extraction device, the sample extraction device comprises:
a transportation fluid connection for providing a transportation fluid, wherein optionally the transportation fluid is an inert gas, preferably nitrogen gas,
in the transportation position of the sampling valve, the sampling space is in fluid communication with the transportation fluid connection in the transportation position of the sampling valve.

In an embodiment of the sample extraction device, the sampling valve is configured to be arranged above the liquid level of the reaction liquid in the reactor volume.

In an embodiment of the sample extraction device, the sample channel comprises a buffer volume arranged between the sampling valve and the sampling fluid connection, wherein the buffer volume is preferably arranged between the sampling valve and the multiway valve.

In an embodiment of the sample extraction device, the sample extraction device comprises:
a secondary fluid valve arranged in the secondary fluid channel and between the secondary fluid connection and the secondary fluid channel entrance, wherein the secondary fluid valve is preferably arranged between the multiway valve and the secondary fluid channel entrance,
   wherein:
the secondary fluid valve is moveable to a secondary blocking position wherein the secondary fluid valve blocks flow through the secondary fluid channel and the secondary fluid valve is moveable to a secondary flow position wherein the secondary fluid valve allows flow through the secondary fluid channel.

In an embodiment of the sample extraction device, the sample extraction device comprises:
a sampling two way valve arranged in the sample channel between the sampling fluid connection and the sampling valve, wherein the sampling two way valve is movable to a sampling open position allowing flow past the sampling two way valve and a sampling closed position not allowing flow past the sampling two way valve, AND/OR
a secondary two way valve arranged in the secondary fluid channel between the secondary fluid connection and the secondary fluid valve, wherein the secondary two way valve is movable to a secondary open position allowing flow past the secondary two way valve and a secondary closed position not allowing flow past the secondary two way valve.

In an embodiment, the method comprising the steps of:
arranging the multiway valve to allow fluid flow between the first multiway connection and the fourth multiway connection and to block fluid flow through the second multiway connection,
injecting sampling fluid into the reactor volume via the sampling fluid connection, the multiway valve and the secondary fluid channel entrance, thereby raising a level of reaction liquid in the sample channel,
subsequently removing fluid from the reactor volume via the sampling fluid connection, the multiway valve and the secondary fluid channel entrance, thereby lowering the level of reaction liquid in the sample channel.

In an embodiment of the method, the method comprising the steps of:
closing the sampling fluid connection and opening the secondary fluid connection,
arranging the multiway valve to allow fluid flow between the second multiway connection, the third multiway connection and the fourth multiway connection, or alternatively alternatingly arranging the multiway valve to:
   allow fluid flow between the third multiway connection and the fourth multiway connection, and to
   allow fluid flow between the second multiway connection and the third multiway connection,

In an embodiment of the method, the step of depressurising the sample extraction device is performed prior to taking a sample from the reactor.

In an embodiment of the method, the method comprising the step of arranging the sampling valve in the sampling position.

In an embodiment of the method, the method comprising the step of arranging the secondary fluid valve in the secondary flow position.

In a twelfth aspect, the invention provides a method of sampling a reaction liquid from a reactor, the method comprising the steps of:
arranging the multiway valve to allow fluid communication between the first multiway connection and the fourth multiway connection,
arranging the sampling valve in the sampling position,
closing the secondary fluid connection,
injecting sampling fluid into the reactor volume via the sampling fluid connection, the multiway valve and the secondary fluid channel entrance, thereby forcing reaction liquid from the reactor volume into the sample channel and into the sampling space, thereby filling the sampling space with a sampling volume of reaction liquid, the sampling volume being equal to the cavity volume,
subsequently arranging the sampling valve in the transportation position,
transporting the sampling volume of reaction liquid from the sampling space through the sample extraction outlet to a suitable destination.

In an embodiment of the method, a volume in the sample channel is sealed from the sampling fluid connection and the secondary fluid connection during the injection of sampling fluid into the reactor volume, such that a pressure in said volume of the sample channel is raised by forcing reaction liquid from the reactor volume into the sample channel.

In an embodiment of the method, the method comprises the steps of:
arranging the multiway valve to allow fluid communication between the first multiway connection and the fourth multiway connection,
injecting sampling fluid into the reactor volume via the sampling fluid connection, the multiway valve and the secondary fluid channel entrance, thereby forcing reaction liquid from the reactor volume into the sample channel into and past the sampling valve and into the buffer volume,
regulating an amount and/or pressure of sampling fluid injected into the reactor volume to control a level of the reaction liquid in the buffer volume.

In an embodiment of the method, the method comprises the step of:
preventing the reaction liquid forced into the sample channel from reaching the multi way valve by regulating an amount and/or pressure of sampling fluid injected into the reactor volume to control a level of the reaction liquid in the buffer volume.

In an embodiment of the method, the method comprises the step of:
arranging the secondary fluid valve in the secondary flow position, before injecting sampling fluid into the reactor volume.

In an embodiment of the method, the method comprises the step of:
arranging the secondary fluid valve in the secondary blocking position after filling the sampling space with a sampling volume of reaction liquid.

In an embodiment of the method, the method comprises the steps of, prior to taking the sample from the reactor:
arranging the multiway valve to allow fluid flow between the first multiway connection and the second multiway connection and between the third multiway connection and the fourth multiway connection,
injecting a cleaning fluid into the reactor volume from the sampling fluid connection via the sample channel, thereby blowing any reaction liquid out of the sample channel, wherein optionally the cleaning fluid is an inert gas such as nitrogen gas,
removing the cleaning fluid from the reactor volume via the secondary fluid channel and the secondary fluid connection.

In a thirteenth aspect, the invention provides a method of sampling a reaction liquid combining the steps of at least two of the embodiments of the eleventh or twelfth aspects.

As shown above, the sample extraction device according to the invention may comprise either two three way valves and two crossovers, or a multiway valve, or another valving system. It will be clear that these can be replaced by any system of valves and/or tubes that can provide the required functionality, that is to be controllable to form the flow paths required to execute the required method steps, for example by configurably interconnecting the sample channel and the secondary channel.

These and other aspects of the invention will be more readily appreciated as the same becomes better understood by reference to the following detailed description and considered in connection with the accompanying drawings in which like reference symbols designate like parts. It will be clear to the skilled person that the features of any of the above embodiments can be combined.

### BRIEF DESCRIPTION OF THE FIGURES

Embodiments of the laboratory system according to the invention and the extraction device according to the invention and the method according to the invention will be described by way of example only, with reference to the accompanying schematic drawings in which corresponding reference symbols indicate corresponding parts, and in which:

FIG. 1 shows a schematic depiction of a laboratory system according to the invention.

FIG. 2 shows a schematic depiction of a sample extraction device according to the invention.

FIG. 3 shows a laboratory system according to the invention.

FIG. 4A shows an embodiment of a sample extraction device according to the invention.

FIG. 4B shows the sample extraction device of FIG. 4A while performing a cleaning step.

FIG. 4C shows the sample extraction device of FIG. 4A while performing a rinsing step.

FIG. 4D shows the sample extraction device of FIG. 4A while performing a pressure equalisation step.

FIG. 4E shows the sample extraction device of FIG. 4A with a sample drawn up from the reactor volume.

FIG. 4F shows the sample extraction device of FIG. 4A in a sample transportation configuration.

FIG. 5A shows a different embodiment of a sample extraction device according to the invention.

FIG. 5B shows the sample extraction device of FIG. 5A while performing a cleaning step.

FIG. 5C shows the sample extraction device of FIG. 5A while performing a rinsing step.

FIG. 5D shows the sample extraction device of FIG. 5A while performing a first part of a pressure equalisation step.

FIG. 5E shows the sample extraction device of FIG. 5A while performing a second part of a pressure equalisation step.

FIG. 5F shows the sample extraction device of FIG. 5A with a sample drawn up from the reactor volume.

FIG. 5G shows the sample extraction device of FIG. 5A in a sample transportation configuration.

FIG. 5H shows yet another different embodiment of a sample extraction device according to the invention.

### DETAILED DESCRIPTION OF THE FIGURES

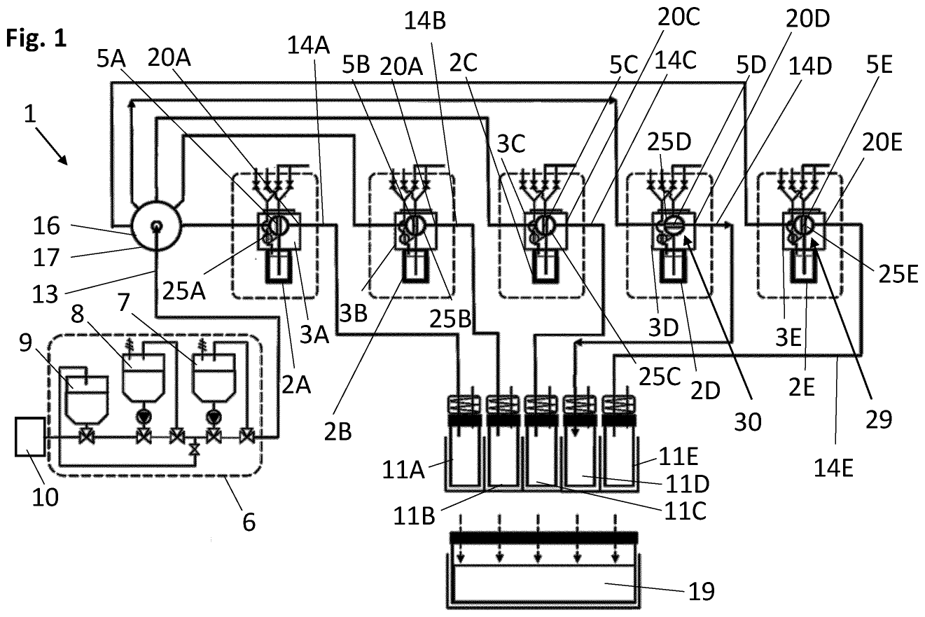

FIG. 1 shows a schematic depiction of a laboratory system 1 according to the invention. The laboratory system 1 comprises five reactors 2A, 2B, 2C, 2D, 2E, for example thermal cycle reactors, each being associated with a respective sample extraction device 3A, 3B, 3C, 3D, 3E for extracting a sample from the reactor 2A, 2B, 2C, 2D, 2E. The laboratory system 1 further comprises a fluid supply system 6 comprising a transportation fluid supply 10 for supplying a transportation fluid. Said transportation fluid comprises nitrogen gas or any other suitable fluid, for example a substantially inert fluid such as a noble gas. The fluid supply system 6 further comprises a quench fluid supply 7, a dilution fluid supply 8 and a rinsing fluid supply 9. The fluid supply system 6 is connected to the extraction devices 3A, 3B, 3C, 3D, 3E via a fluid supply channel 13, through which fluid from the fluid supply system 6, such as transportation fluid from the transportation fluid supply 10, is transported to the extraction devices 3A, 3B, 3C, 3D, 3E. Five sample storage containers 11A, 11B, 11C, 11D, 11E are provided for storing samples extracted from the reactors 2A, 2B, 2C, 2D, 2E. The storage containers 11A, 11B, 11C, 11D, 11E are connected to the reactors 2A, 2B, 2C, 2D, 2E via sample extraction channels 14A, 14B, 14C, 14D, 14E.

When a sample is taken from one of the reactors 2A, 2B, 2C, 2D, 2E, a sample is first extracted from the reactor 2A, 2B, 2C, 2D, 2E into the sampling space 5A, 5B, 5C, 5D, 5E. The fluid supply system 6 then pushes the sample from the sampling space 5A, 5B, 5C, 5D, 5E through the sample extraction channel 14A, 14B, 14C, 14D, 14E to the sample storage container 11A, 11B, 11C, 11D, 11E using transportation fluid of the transportation fluid supply 10.

The laboratory system 1 may further comprise multiple storage containers 11A, 11B, 11C, 11D, 11E associated with each of the reactors 2A, 2B, 2C, 2D, 2E, such that multiple samples may be taken from each reactor 2A, 2B, 2C, 2D, 2E. A container selection system (not imaged) is provided to associate the sample extraction channel 14A, 14B, 14C, 14D, 14E with one of the multiple sample storage containers 11A, 11B, 11C, 11D, 11E, such that each sample may be stored in a separate sample storage container 11A, 11B, 11C, 11D, 11E.

Seeing that the laboratory system 1 comprises multiple reactors 2A, 2B, 2C, 2D, 2E, a reactor selection system is provided to select a reactor from which a sample is to be taken. Two variants of such a reactor selection system are disclosed, being an upstream reactor selection system 16 as shown in FIG. 1 and a downstream reactor selection system (not imaged).

In the imaged embodiment, each reactor 2A, 2B, 2C, 2D, 2E is associated with a respective sample extraction device 3A, 3B, 3C, 3D, 3E having a respective sampling space 5A, 5B, 5C, 5D, 5E. The sample extraction devices 3A, 3B, 3C, 3D, 3E are configured for extracting a sample from the reactor 2A, 2B, 2C, 2D, 2E into the sampling space 5A, 5B, 5C, 5D, 5E. Each sample extraction device 3A, 3B, 3C, 3D, 3E is connected to a respective sample storage container 11A, 11B, 11C, 11D, 11E by the sample extraction channel 14A, 14B, 14C, 14D, 14E. The fluid supply channel 13 connects the fluid supply system 6 to each sample extraction device 3A, 3B, 3C, 3D, 3E. An upstream reactor selection system 16 comprising a 5-way valve 17 arranged in the fluid supply channel 13 is provided to bring a chosen sample extraction device 3A, 3B, 3C, 3D, 3E of one of the reactors 2A, 2B, 2C, 2D, 2E in fluid communication with the fluid supply system 6. In FIG. 1, the sample extraction device 3D of the fourth reactor 2D is shown in fluid communication with the fluid supply system 6, while the sample extraction devices 3A, 3B, 3C, 3E of the first, second, third and fifth reactors 2A, 2B, 2C, 2E are not in fluid communication with the fluid supply system 6. In an alternative embodiment, each sample extraction device 3A, 3B, 3C, 3D, 3E may comprise a valve for regulating fluid communication with the fluid supply system 6, such that the 5-way valve 17 is not necessary.

Alternatively, a single sample extraction device 3 connected to each of the reactors 2A, 2B, 2C, 2D, 2E via a downstream reactor selection system may be used. In such an embodiment, the reactor 2A, 2B, 2C, 2D, 2E, from which a sample is to be taken by the single sample extraction device 3 is determined by the downstream reactor selection system. Such a downstream reactor selection system may also comprise a 5-way valve for bringing the sample extraction device 3 in fluid communication with one of the reactors 2A, 2B, 2C, 2D, 2E.

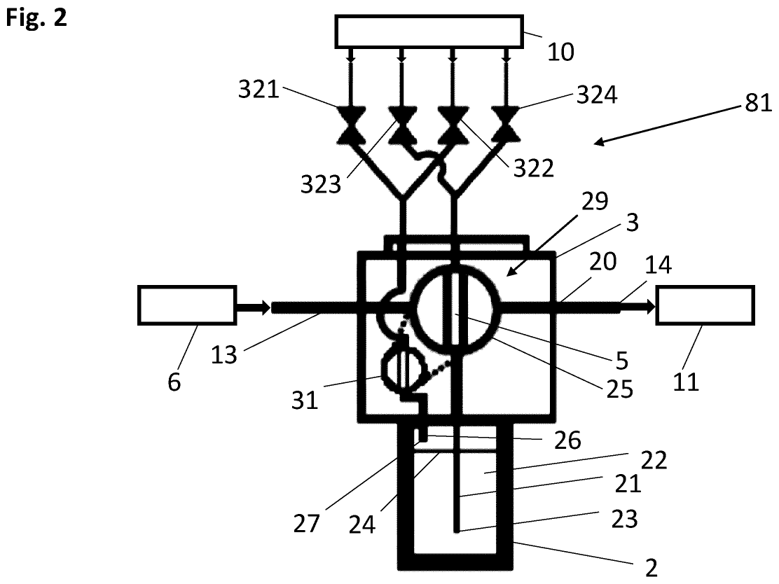

FIG. 2 shows a schematic depiction of a sample extraction device 3 in more detail. The sample extraction device 3 comprises a sample channel 21 extending into the reactor volume 22 of the reactor 2 with a sample channel entrance 23 arranged below a liquid level 24 of a reaction liquid in the reactor volume 22 of the reactor 2. A sampling valve 25 is provided in the sampling channel 21 which is movable, for example rotatable, between a sampling position 29 and a transportation position 30. The sampling valve 25 is arranged above the liquid level 24 of the reaction liquid. In the sampling position 29, a sampling space 5 with a cavity volume provided in the sampling valve 25 is in fluid communication with the sample channel 21 and in the transportation position 30, the sampling space 5 is in fluid communication with the fluid supply channel 13 and, via a sample extraction outlet 20, with the sample extraction channel 14. The sample extraction device 3 further comprises a secondary fluid channel 26 extending into the reactor volume 22, the secondary fluid channel 26 comprising a secondary fluid channel entrance 27 arranged in the reactor volume 22. The secondary fluid channel 26 is connectable to the transportation fluid supply 10.

Sampling may be initiated by registration of a sample trigger such as a time measurement, a temperature measurement, a measurement of a reactor process parameter such as a crystallization parameter, a transmissivity measurement or any other measurement reaching a certain threshold value, or a user input, or any other trigger. Taking a sample using the laboratory system 1 comprises first selecting the reactor 2A, 2B, 2C, 2D, 2E using the reactor selection system 16. A sample is then extracted from the reactor 2A, 2B, 2C, 2D, 2E into the sampling space 5A, 5B, 5C, 5D, 5E of the associated sample extraction device 3A, 3B, 3C, 3D, 3E. The sample is subsequently transported to the sample storage container 11A, 11B, 11C, 11D, 11E via the sample extraction channel 14A, 14B, 14C, 14D, 14E by supplying the transportation fluid to the sampling space 5A, 5B, 5C, 5D, 5E via the fluid supply channel 13. A sample can thus be taken under reactor conditions so as to minimize disturbance to reactor processes occurring inside the reactor, such as chemical processes and crystallization processes. Referring back to FIG. 1, the sampling valve 25D of the sample extraction device 3D of the fourth reactor 2D is arranged in the transportation position 30 such that the sampling space 5D is in fluid communication with the fluid supply channel 13 and, via a sample extraction outlet 20D, with the sample extraction channel 14D. The sampling valves 25A, 25B, 25C, 25E of the sample extraction devices 3A, 3B, 3C, 3E of the first, second, third and fifth reactors 2A, 2B, 2C, 2E are arranged in the sampling position 29 such that the respective sampling spaces 5A, 5B, 5C, 5E are in fluid communication with the fluid supply channel 13 and, via the respective sample extraction outlets 20A, 20B, 20C 20E, with the respective sample extraction channels 14A, 14B, 14C, 14E.

As an additional step, a quench fluid to extinguish a chemical reaction occurring in the sample may be supplied to the sample from the quench fluid supply 7. The quench fluid supply 7 is preferably connected to the sample extraction device 3A, 3B, 3C, 3D, 3E via the fluid supply channel 13, preferably downstream from the transportation fluid supply 10. This way, the transportation fluid can be used to transport the quench fluid to the sample space 5A, 5B, 5C, 5D, 5E. The quench fluid may be supplied to the sample before, during or after transport of the sample to the sample storage container 11A, 11B, 11C, 11D, 11E. The quench fluid may already be present in the sample storage container 11A, 11B, 11C, 11D, 11E before the sample is transported to the sample storage container 11A, 11B, 11C, 11D, 11E.

As an additional step, a dilution fluid to dilute the sample may be supplied to the sample from the dilution fluid supply 8. The dilution fluid supply 8 is preferably connected to the sample extraction device 3A, 3B, 3C, 3D, 3E via the fluid supply channel 13, preferably downstream from the transportation fluid supply 10. This way, the transportation fluid can be used to transport the dilution fluid to the sample. The dilution fluid may be supplied to the sample before, during or after transport of the sample to the sample storage container 11A, 11B, 11C, 11D, 11E. The dilution fluid may already be present in the sample storage container 11A, 11B, 11C, 11D, 11E before the sample is transported to the sample storage container 11A, 11B, 11C, 11D, 11E.

As an additional step, a rinsing fluid may be supplied to the fluid supply channel 13 and the sampling space 5A, 5B, 5C, 5D, 5E and the sample extraction channel 14A, 14B, 14C, 14D, 14E after storing the sample in the sample storage container 11A, 11B, 11C, 11D, 11E. The rinsing fluid is then deposited in a waste container 19. This ensures that no residue is left behind in the fluid supply channel 13 and the sampling space 5A, 5B, 5C, 5D, 5E and the sample extraction channel 14A, 14B, 14C, 14D, 14E after taking a sample, such that a next sample is not contaminated by such residue.

Using the transportation fluid to transport the quench fluid, the dilution fluid and/or the rinsing fluid through at least part of the fluid supply channel 13, the sampling space 5A, 5B, 5C, 5D, 5E and/or the sample extraction channel 14A, 14B, 14C, 14D, 14E provides an efficient way of transporting these fluids. In addition, the use of the transportation fluid to subsequently transport two fluids may create a separation between the two fluids. This prevents mixing of for example quench liquid and dilution fluid in the fluid supply channel 13, the sampling space 5A, 5B, 5C, 5D, 5E and/or the sample extraction channel 14A, 14B, 14C, 14D, 14E when transported subsequently through these channels. The use of transportation fluid for transport of the quench fluid, the dilution fluid and/or the rinsing fluid may be combined with fluid pumps, for example fluid pumps provided in the quench fluid supply 7, the dilution fluid supply 8 and the rinsing fluid supply 9.

Extraction of a sample from the reactor 2 into the sampling space 5 is performed by injecting the transportation fluid into the reactor volume 22 via the secondary fluid channel 26 while the sampling valve 25 is in the sampling position 29, thereby creating a pressure differential between the reactor volume 22 and the sampling space 5. This forces the fluid in the reactor volume 22 into the sample channel 21 via the sample channel entrance 23 and into the sampling space 5. The pressure in the reactor volume 22 as well as injection of transportation fluid into the reactor volume 22 is controlled via sampling control valves 321, 322, 323, 324. A first sampling control valve 321 and a second sampling control valve 322 are connected to the secondary fluid channel 26 via a secondary fluid valve 31. A third sampling control valve 323 and a fourth sampling control valve 324 are connected to the sample channel 21 via the sampling valve 25.

After the sample is extracted from the reactor 2 into the sampling space 5, the sampling valve 25 is arranged in the transportation position 30. A sample comprising a sample volume of reaction liquid from the reactor 2 is then present in the sampling space 5, the sample volume being equal to the cavity volume of the sampling space 5. The sample is subsequently transported from the sampling space 5 through the sample extraction 20 outlet into the sample extraction channel and from there into the sample storage container 11 or any other suitable destination.

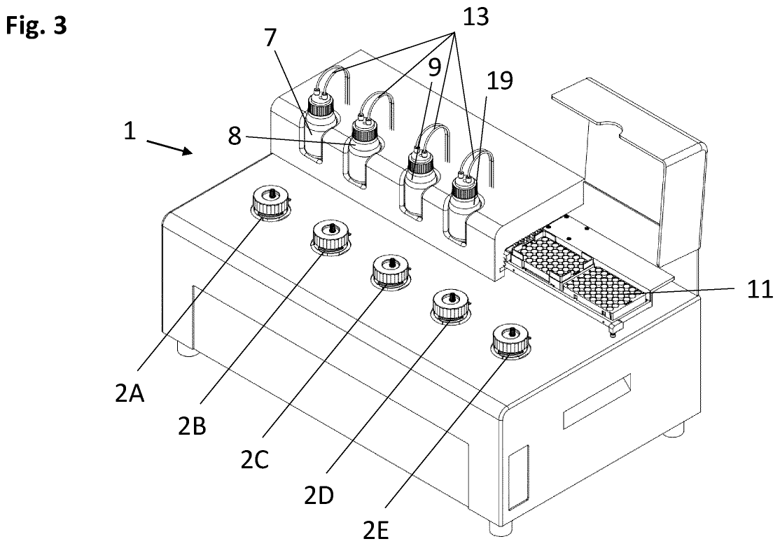

FIG. 3 shows a laboratory system 1 according to the invention. Multiple sample storage containers 11 are provided for each reactor 2A, 2B, 2C, 2D, 2E, such that multiple samples may be taken from each reactor 2A, 2B, 2C, 2D, 2E.

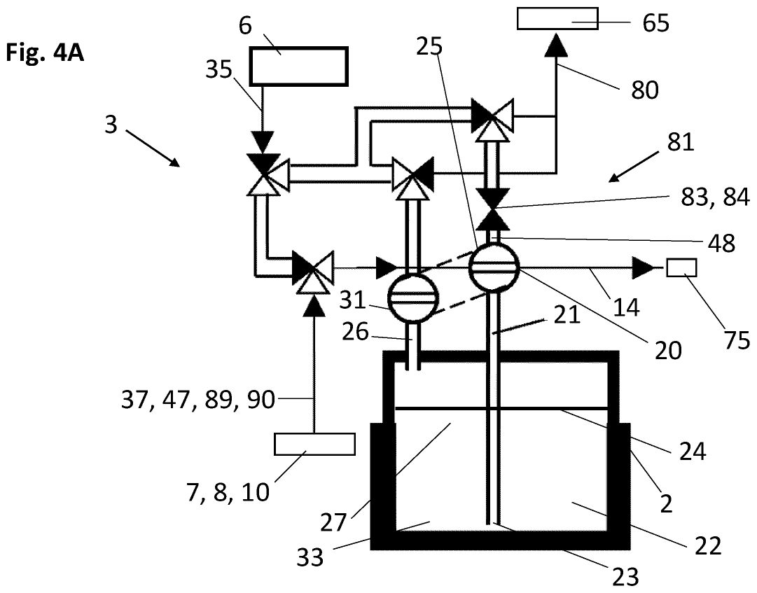

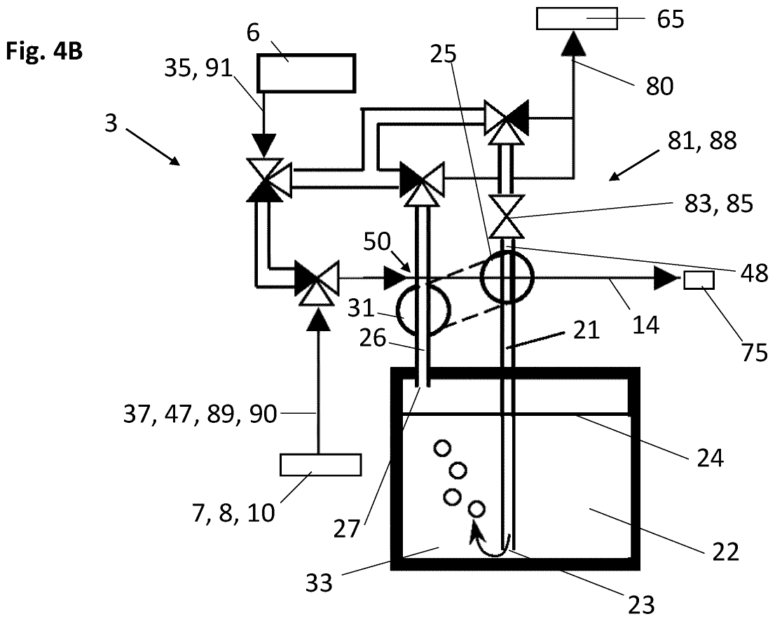

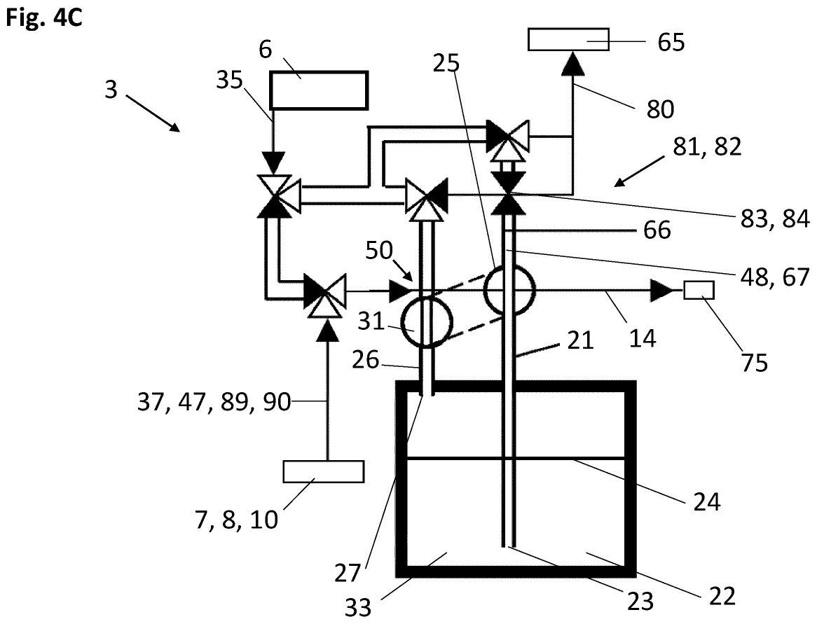

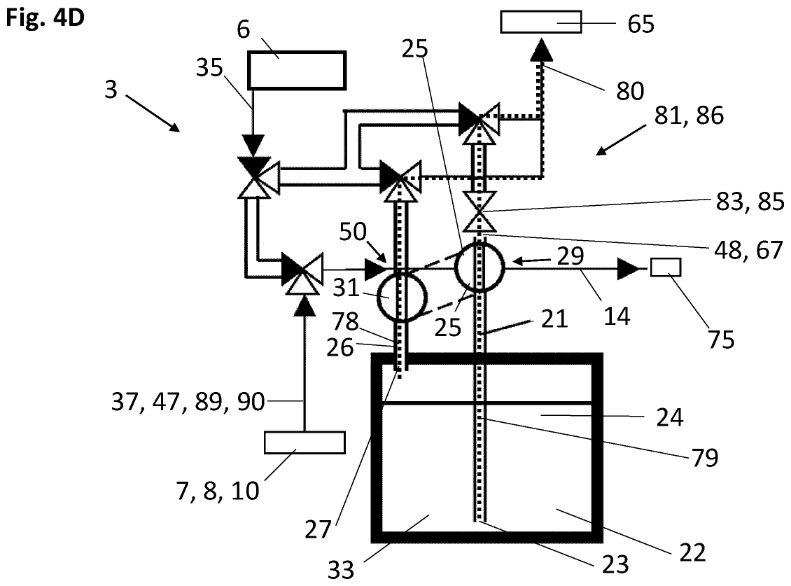

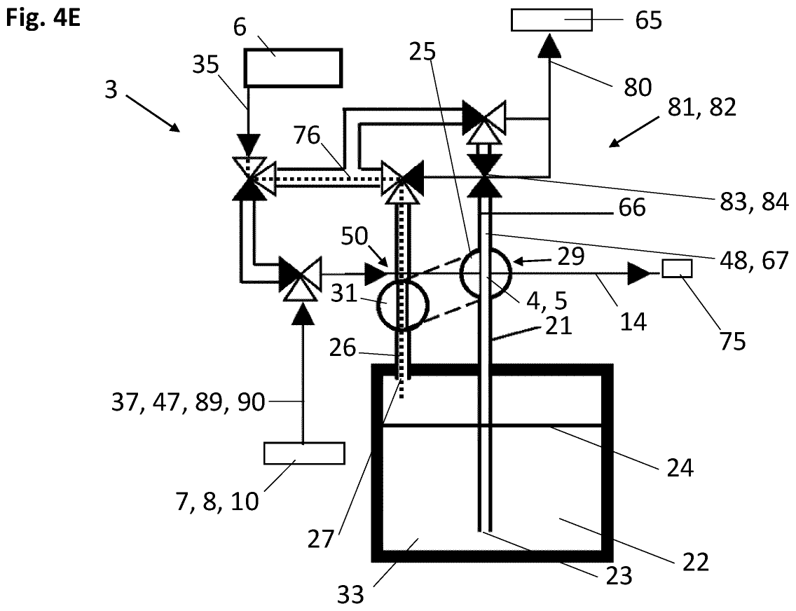

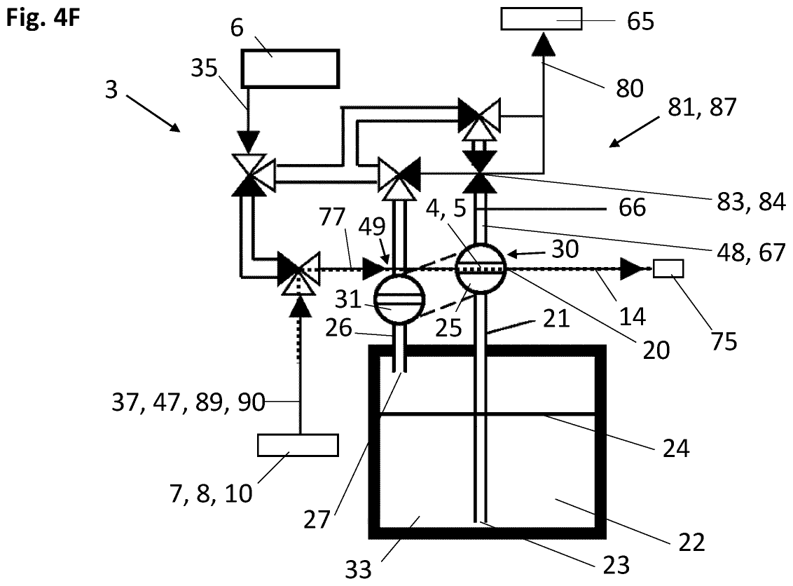

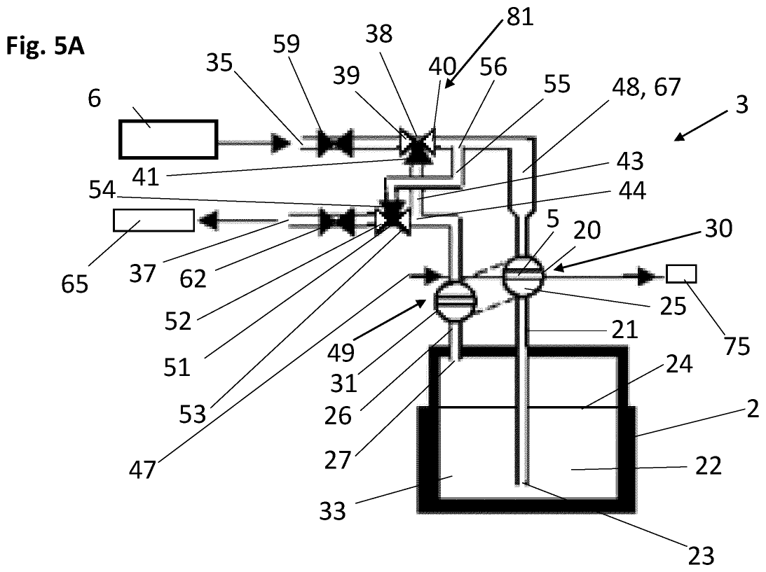

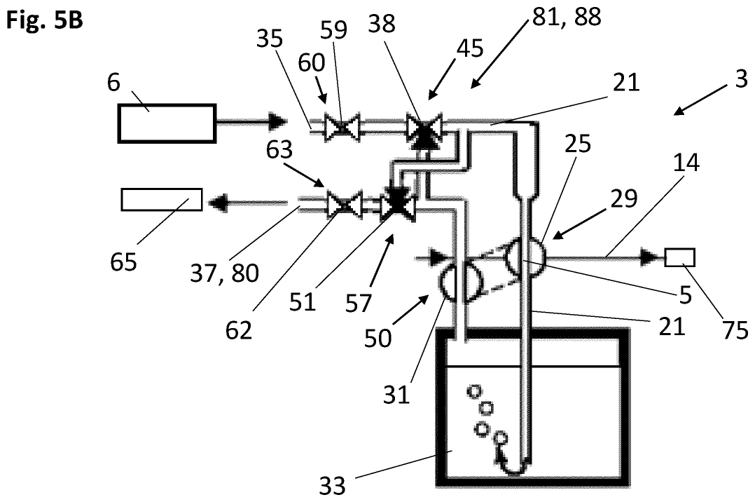

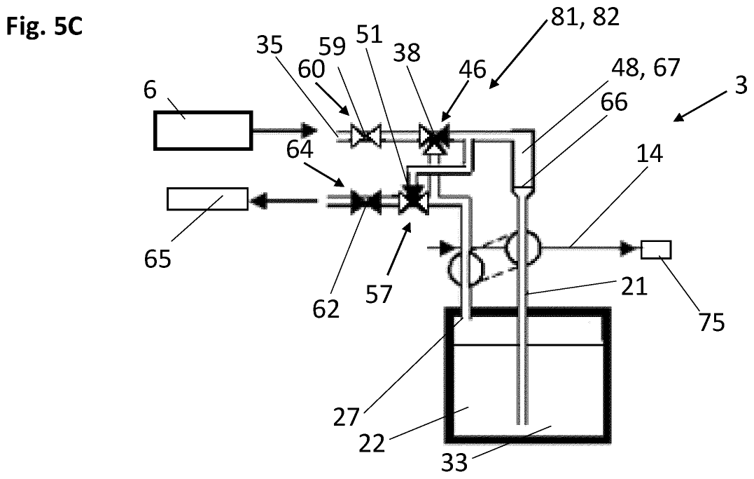

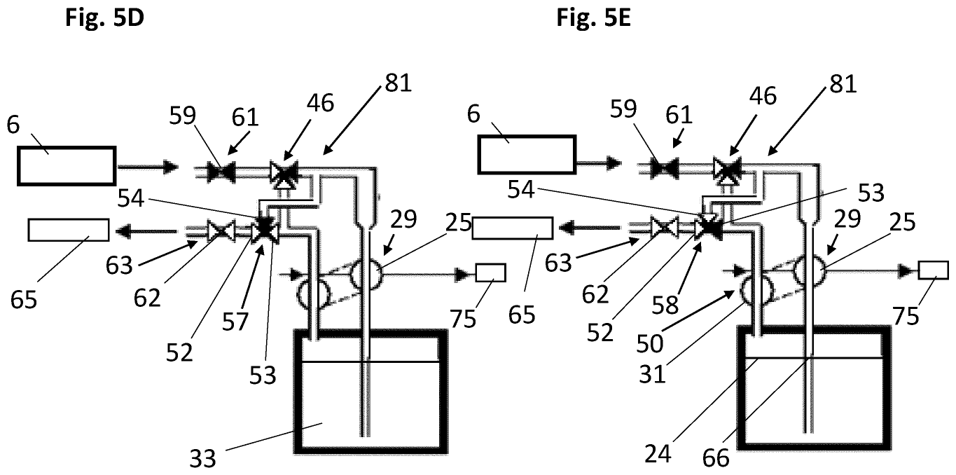

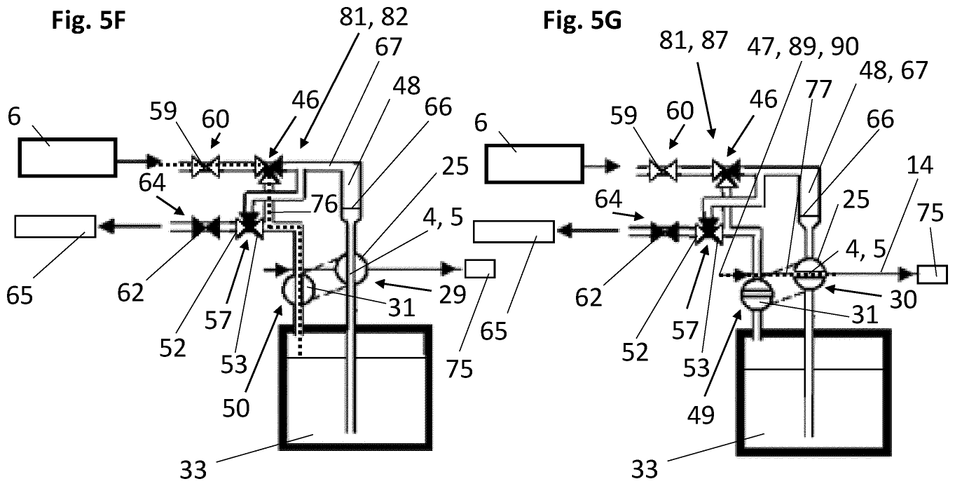

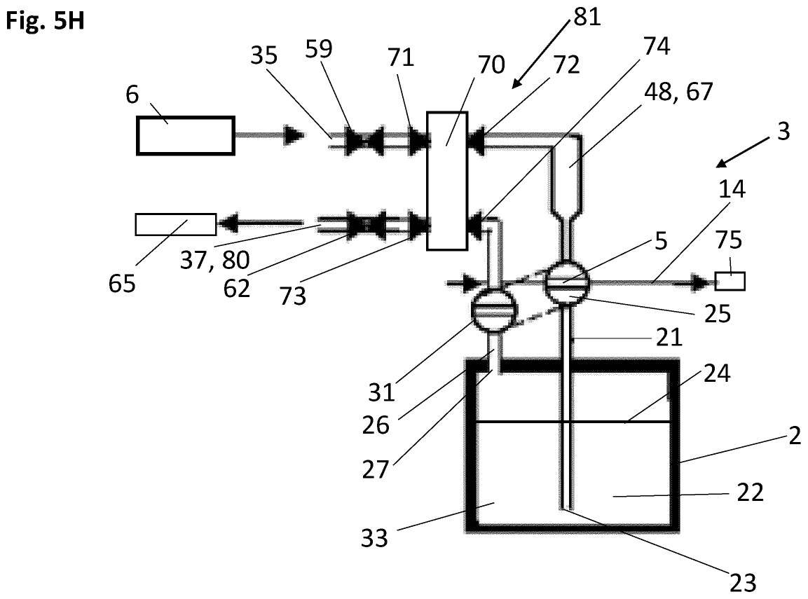

In FIGS. 4A-5E , the valves are drawn as double or triple triangles. A solid black triangle indicates that that connection of the valve is closed, whereas a white filled triangle indicates that that connection of the valve is open. Thus, a closed inline valve is drawn as two solid black triangles (see e.g. valve 83 in FIG. 4A) and an open inline valve is drawn as two white filled triangles (see e.g. valve 83 in FIG. 4B). Three way valves are drawn with one black triangle and two white triangles, indicating that one of the three connections is closed whereas the other two are interconnected.

FIGS. 4A-4F show an embodiment of a sample extraction device 3 according to the invention. FIG. 5A-5G show a different embodiment of a sample extraction device 3 according to the invention. FIG. 5H shows yet another embodiment of a sample extraction device 3 according to the invention. The valving system 81 is configured differently in these three embodiments. However, in all three embodiments, by appropriate arrangement of the valves of the valving system 81 of these embodiments, the flow paths required to perform the necessary method steps can be made.

FIG. 4A shows an embodiment of a sample extraction device 3 according to the invention. The sample extraction device 3 comprises a sample channel 21 extending into the reactor volume 22 of the reactor 2 with a sample channel entrance 23 arranged below a liquid level 24 of a reaction liquid in the reactor volume 22 of the reactor 2. The sample extraction device 3 further comprises a valving system 81 connected to the sample channel 21, a secondary fluid channel 26, a sampling fluid connection 35, a secondary fluid connection 37, a sample extraction outlet 20, and an offgas connection 80. In the embodiment imaged in FIGS. 4A-4F , the secondary fluid connection 37 is also the transportation fluid connection 47, the quench fluid connection 89, and the dilution fluid connection 90. Alternatively, the offgas connection 80 may be integrated into from the secondary fluid connection 37, while the secondary fluid connection 37 and the transportation fluid connection 47 are separate (see FIGS. 5A-5G) . A sampling valve 25 is provided in the sampling channel 21 which is movable, for example rotatable, between a sampling position 29 and a transportation position 30. The sampling valve 25 is arranged above the liquid level 24 of the reaction liquid 33. In the sampling position 29, a sampling space 5 with a cavity volume provided in the sampling valve 25 is in fluid communication with the sample channel 21 and in the transportation position 30, the sampling space 5 is in fluid communication with the transportation fluid connection 47, the quench fluid connection 89, and the dilution fluid connection 90, and the sample extraction outlet 20. The sample extraction device 3 further comprises a secondary fluid channel 26 extending into the reactor volume 22, the secondary fluid channel 26 comprising a secondary fluid channel entrance 27 arranged in the reactor volume 22, preferably above the level 24 of the reaction liquid 33 in the reactor volume 22.

The sampling fluid connection 35 is configured to provide a pressurised sampling fluid to sample extraction device 3 via the sampling fluid connection 35, the sampling fluid preferably being an inert gas such as nitrogen gas. The sampling valve 25 is arranged between the sampling fluid connection 35 and the sample channel entrance 23. The sampling valve comprises a sampling space 5 with a cavity volume and is moveable to a sampling position 29 and a transportation position 30. In the sampling position 29, the sampling space is in fluid communication with the sample channel 21. In the transport position 30, the sampling space is in fluid communication with a sample extraction outlet 20 and a transportation fluid connection 47.

A secondary fluid valve 31 is arranged in the secondary fluid channel 26 between the secondary fluid connection 37 and the secondary fluid channel entrance 27. The secondary fluid valve 31 is in particular located such that there are no further flow junctions between the secondary fluid valve 31 and the secondary fluid channel entrance 27.

The secondary fluid valve 31 is moveable to a secondary blocking position 49 wherein the secondary fluid valve 31 blocks flow through the secondary fluid channel 26. The secondary fluid valve 31 is also moveable to a secondary flow position 50 wherein the secondary fluid valve 31 allows flow through the secondary fluid channel 26. When extracting a sample from the reactor volume 22, the secondary fluid valve 31 is arranged in the secondary flow position 50 before sampling fluid is injected into the reactor volume 22. After the sampling space 5 is filled with a sampling volume of reaction liquid 33, the secondary fluid valve 31 is arranged in the secondary blocking position 49.

The valving system 81 is arrangeable in a sampling configuration 82 (see FIG. 4E), a depressurising configuration 86 (see FIG. 4D), a transport configuration 87 (see FIG. 4F) and a cleaning configuration 88 (see FIG. 4B). Below, these configurations and the methods steps performed using these configurations are discussed in more detail.

The cleaning configuration 88 of the valving system 81 is shown in FIG. 4B. The cleaning configuration 88 is used to clean the sample tube 21 by blowing a cleaning fluid through it from a cleaning fluid connection 91. In the imaged embodiment, the cleaning fluid connection 91 is the sampling fluid connection 35 and the cleaning fluid is the sampling fluid. In the cleaning configuration 88 of the valving system 81, the cleaning fluid connection 91 is in fluid communication with the sample channel entrance 23 and the secondary fluid channel entrance 27 is in fluid communication with the offgas connection 80. Cleaning fluid is injected into the reactor volume from the cleaning fluid connection 91 and the sample channel entrance 23. Subsequently, flow occurs from the reactor volume to the secondary fluid channel entrance 27 to the offgas connection 80. This blows residue and/or reaction liquid out of the sample channel 21 and cleans the sample channel 21.

Alternatively or additionally to cleaning, a rinsing step may be performed. The valving system 81 is then arranged as shown in FIG. 4C. This is a similar configuration of the valving system 81 as in the sampling configuration shown 82 in FIG. 4E. During the rinsing step, sampling fluid is injected into the reactor volume 22 via the secondary fluid channel entrance 27, such that a level 66 of reaction liquid 33 in the sample channel 21 is raised. Subsequently, said level of reaction liquid is lowered by removing fluid from the reactor volume 22 via the secondary fluid channel entrance 27. By repeating this process a number of times, for example twice, four times, or even more, the sample channel 21 is rinsed, although raising and lowering the level of reaction liquid in the sample channel 21 just once may also be sufficient. This rinsing is preferably performed before taking a sample. Rinsing the sampling tube 21 ensures that any sample taken from the reactor volume 22 comprises reaction liquid 33 from the reactor volume 22 rather than old reaction liquid 33 which may be left in the sample channel 21 from a previous sampling operation.

The depressurising configuration 86 of the valving system 81 is shown in FIG. 4D. The depressurising configuration 86 is used to depressurise the sample extraction device 3 prior to taking a sample. In the depressurising configuration 86, the sampling valve 25 is in the sampling position 29. And a third flow path 78 and a fourth flow path 79 are formed. The third flow path 77 extends from the secondary fluid channel entrance 27 to the offgas connection 80 and the fourth flow path extends from the sample channel entrance 23 to the offgas connection 80. The secondary fluid channel entrance 27 is in fluid communication with the offgas connection 80 via the third flow path 78 and the sample channel entrance 23 is in fluid communication with the offgas connection 80 via the fourth flow path 79. This way, both the sample channel 21 and the secondary fluid channel 26 can be depressurised to the pressure of the offgas connection 80 and the offgas area 65 to which the offgas connection 80 is connected. This depressurising is preferably performed before taking a sample.

The sampling configuration 82 of the valving system 81 is shown in FIG. 4E. The sampling configuration 82 is used when taking a sample. In the sampling configuration 82, the sampling valve 25 is in the sampling position 29, and the secondary fluid channel entrance 27 is in fluid communication with the sampling fluid connection 35 via the secondary fluid valve 31 which is in the secondary flow position 50. The sample channel entrance 23 is not in fluid communication with the offgas connection 80. The sample blocking valve 83 is arranged in its blocking position 84 when the valving system 81 is in the sampling configuration 82. This closes the buffer volume 48 from the rest of the system, the buffer volume 48 being arranged between the sampling valve 25 and the sample blocking valve 83, preventing the sample from passing into the system beyond the sample blocking valve 83. This reduces a risk of damage or contamination of the system. The sample blocking valve 83 is arranged in the sample channel 21 between the sampling valve 25 and the sampling fluid connection 35, in particular between the sampling valve 25 and the offgas connection 80. Alternatively, the sample blocking valve 83 may be arranged in the sample channel 21 between the sampling valve 25 and the offgas connection 80, for example if the connections are laid out differently such that there is no flow path from the sampling valve 25 to the sampling fluid connection 35.

To take a sample, the valving system 81 is arranged in the sampling configuration 82 as shown in FIG. 4E. The sampling fluid connection 35 is brought into fluid communication with the secondary fluid channel entrance. This forms a first flow path 76 which extends from the sampling fluid connection 35 to the secondary fluid channel entrance 27. The sampling valve 25 is arranged in the sampling position 29. The sample is then drawn into the sample channel 21 and into the sampling space 5 of the sampling valve 25 by injecting sampling fluid into the reactor volume 22 via the first flow path 76 and the secondary fluid channel entrance 27.

Reaction liquid 33 is thus forced into the sampling space 5 of the sampling valve 25, such that the sampling space 5 is filled with a sampling volume of reaction liquid 33, the sampling volume being equal to the cavity volume of the sampling space 5. The level 66 of reaction liquid 33 in the sample channel 21 is raised past the sampling space 5 of the sampling valve 25, and a pressure in said volume 67 of the sample channel 21 is also raised as the sample blocking valve 83 is in its blocking position 84. This sealed volume 67 is the buffer volume 48, it is arranged between the sampling valve 25 and the sampling fluid connection 35. The volume of the buffer volume is chosen by choosing length and width of tubing and/or a volume of a buffer space such that this rise in pressure is adequate to provide the proper countering force to the reaction liquid rising in the sample channel. The amount and/or pressure of the sampling fluid injected into the reactor is regulated to control the level of reaction liquid 33 in the sample channel 21.

The valving system 81 is subsequently arranged in the transport configuration 87 to form the second flow path 77, see FIG. 4F. The transport configuration 87 is used after taking a sample, to send the sample to a suitable destination 75. This suitable destination could be for example a storage vial or an analysis tool. In the transport configuration 87, the sampling valve 25 is in the transportation position 30 configuration and the secondary fluid connection 37 is in fluid communication with the sampling space 5, such that the second flow path 77 is formed. The second flow path 77 extends from the secondary fluid connection 37 to the sample extraction outlet 20. A transportation fluid, a quench fluid and/or a dilution fluid is fed to the sampling space 5 via the second flow path 77.

In the imaged embodiment, the secondary fluid connection 37 comprises the transportation fluid connection 47, the quench fluid connection 89 and the dilution fluid connection 90. Thus, in the transport configuration, the sampling space is also in fluid communication with the transportation fluid connection 47, the quench fluid connection 89 and the dilution fluid connection 90. In the transport configuration 87, the sample extraction outlet 20 is in fluid communication with the secondary fluid connection 37 (and the transportation fluid connection 47, the quench fluid connection 89 and the dilution fluid connection 90) and the sample channel entrance 23 is not in fluid communication with the sampling fluid connection 35.

FIG. 5A shows an embodiment of a sample extraction device 3 according to the invention. The sample extraction device 3 comprises a sample channel 21 extending into the reactor volume 22 of the reactor 2 with a sample channel entrance 23 arranged below a liquid level 24 of a reaction liquid in the reactor volume 22 of the reactor 2. The sample extraction device 3 further comprises a valving system 81 connected to the sample channel 21, a secondary fluid channel 26, a sampling fluid connection 35, a secondary fluid connection 37, a sample extraction outlet 20, and an offgas connection 80. In the embodiment imaged in FIGS. 5A-5H , the secondary fluid connection 37 is also the offgas connection 80. A separate transportation fluid connection 47 is also provided. Alternatively, the offgas connection 80 may be separate from the secondary fluid connection 37, while the secondary fluid connection 37 and the transportation fluid connection 47 are integrated (see FIGS. 4A-4F) . A sampling valve 25 is provided in the sampling channel 21 which is movable, for example rotatable, between a sampling position 29 and a transportation position 30. The sampling valve 25 is arranged above the liquid level 24 of the reaction liquid 33. In the sampling position 29, a sampling space 5 with a cavity volume provided in the sampling valve 25 is in fluid communication with the sample channel 21 and in the transportation position 30, the sampling space 5 is in fluid communication with the transportation fluid connection 47 and the sample extraction outlet 20. The sample extraction device 3 further comprises a secondary fluid channel 26 extending into the reactor volume 22, the secondary fluid channel 26 comprising a secondary fluid channel entrance 27 arranged in the reactor volume 22.

The sampling fluid connection 35 is configured to provide a pressurised sampling fluid to sample extraction device 3 via the sampling fluid connection 35, the sampling fluid preferably being an inert gas such as nitrogen gas. The sampling valve 25 is arranged between the sampling fluid connection 35 and the sample channel entrance 23, in particular between the sampling three way valve 38 and the sample channel entrance 23. The sampling valve comprises a sampling space 5 with a cavity volume and is is moveable to a sampling position 29 and a transportation position 30. In the sampling position 29, the sampling space is in fluid communication with the sample channel 21. In the transport position 30, the sampling space is in fluid communication with a sample extraction outlet 20 and a transportation fluid connection 47.

The sample extraction device 3 comprises a sampling three way valve 38 arranged in the sample channel 21, between the sampling fluid connection 35 and the sample channel entrance 23. The sampling three way valve 38 comprises a first sampling connection 39, a second sampling connection 40 and a third sampling connection 41. The first sampling connection 39 and the second sampling connection 40 are connected inline with the sample channel 21 and the third sampling connection 41 is connected to a sampling crossover tube 43 which is connected with the secondary fluid channel 26 at a secondary crossover connection 44. The first sampling connection 39 is arranged between the second sampling connection 40 and the sampling fluid connection 35 and the second sampling connection 40 is arranged between the first sampling connection 39 and the sample channel entrance 23. The sampling crossover connection is arranged between the sampling three way valve 38 and the sampling valve 25.

The sampling three way valve 38 is movable to a sampling inline passing position 45 wherein fluid flow is allowed between the first sampling connection 39 and the second sampling connection 40 and wherein no fluid flow is allowed through the third sampling connection 41. The sampling three way valve 38 is also movable to a first sampling crossover position 46 wherein fluid flow is allowed between the first sampling connection 39 and the third sampling connection 41 and wherein no fluid flow is allowed through the second sampling connection 40.

The sample extraction device 3 comprises a secondary three way valve 51 arranged in the secondary fluid channel 26. The secondary three way valve comprises a first secondary connection 52, a second secondary connection 53 and a third secondary connection 54. The first secondary connection 52 and the second secondary connection 53 are connected inline with the secondary fluid channel 26 and the third secondary connection 54 is connected to a secondary crossover tube 55 which is connected with the sample channel 21 at a sampling crossover connection 56. The first secondary fluid connection 52 is arranged between the second secondary fluid connection 53 and the secondary fluid connection 37. The second secondary fluid connection 53 is arranged between the first secondary fluid connection 51 and the secondary fluid channel entrance 27.

The sampling three way valve 38 is arranged between the sampling fluid connection 35 and the sampling fluid channel entrance 23. In particular, the sampling three way valve 38 is arranged between the sampling fluid connection 35 and the sampling crossover connection 56.

The secondary three way valve 51 is arranged between the secondary fluid connection 37 and the secondary fluid channel entrance 27. In particular, the secondary three way valve 51 is arranged between the secondary fluid connection 37 and the secondary crossover connection 44. The secondary crossover connection 44 is arranged between the secondary three way valve 51 and the secondary fluid valve 31.

The secondary three way valve 51 is movable to a secondary inline passing position 57 wherein fluid flow is allowed between the first secondary connection 52 and the second secondary connection 53 and wherein no fluid flow is allowed through the third secondary connection 54. The secondary three way valve 51 is also movable to a first secondary crossover position 58 wherein fluid flow is allowed between the first secondary connection 52 and the third secondary connection 54 and wherein no fluid flow is allowed through the second secondary connection 53.

A secondary fluid valve 31 is arranged in the secondary fluid channel 26 between the secondary fluid connection 37 and the secondary fluid channel entrance 27, in particular between the secondary three way valve 51 and the secondary fluid channel entrance 27. The secondary fluid valve 31 is moveable to a secondary blocking position 49 wherein the secondary fluid valve 31 blocks flow through the secondary fluid channel 26. The secondary fluid valve 31 is also moveable to a secondary flow position 50 wherein the secondary fluid valve 31 allows flow through the secondary fluid channel 26. When extracting a sample from the reactor volume 22, the secondary fluid valve 31 is arranged in the secondary flow position 50 before sampling fluid is injected into the reactor volume 22. After the sampling space 5 is filled with a sampling volume of reaction liquid 33, the secondary fluid valve 31 is arranged in the secondary blocking position 49.

A sampling two way valve 59 is arranged in the sample channel 21, between the sampling fluid connection 35 and the sampling valve 25, in particular between the sampling fluid connection 35 and the sampling three way valve 38. The sampling two way valve 59 is moveable to a sampling open position 60 allowing flow past the sampling two way valve 59 and to a sampling closed position 61 not allowing flow past the sampling two way valve 59. A secondary two way valve 62 is arranged in the secondary fluid channel 26, between the secondary fluid connection 37 and the secondary fluid valve 31, in particular between the secondary fluid connection 37 and the secondary three way valve 51. The secondary two way valve 62 is moveable to a secondary closed position 64 wherein the secondary two way valve 62 blocks flow through the secondary fluid channel 31 and to a secondary open position 63 wherein the secondary two way valve 62 allows flow through the secondary fluid channel 26.

To take a sample, the sample is drawn into the sample channel 21 by injecting sampling fluid into the reactor volume 22 via the secondary fluid channel entrance 27 while sealing a volume 67 of the sample channel 21 from the sampling fluid connection 35 and the secondary fluid connection 37, thereby raising a level 66 of reaction liquid 33 in the sample channel 21, and raising a pressure in said volume 67 of the sample channel 21. The sample is then extracted from the sample channel 21 and moved to a suitable destination 75, for example for storage or further processing. FIG. 5F shows the sample extraction device 3 of FIG. 5A while a sample is being taken. The valving system 81 is arranged in the sampling configuration 82 to form the first flow path 76. The sampling fluid connection 35 is in fluid communication with the secondary fluid channel entrance 27 to form a first flow path 76 extending from the sampling fluid connection 35 to the secondary fluid channel entrance 27, via the sampling three way valve 38. The sampling three way valve 38 is arranged in the first sampling crossover position 46, the sampling valve 25 is arranged in the sampling position 29 and the secondary fluid connection 37 is closed by arranging the secondary two way valve 62 in the secondary closed position 64. Sampling fluid is injected into the reactor volume 22 along the first flow path 76, via the sampling fluid connection 35, the sampling three way valve 38 and the secondary fluid channel entrance 27, thereby raising a level 66 of reaction liquid 33 in the sample channel 21 above the sampling valve 25. Reaction liquid 33 is then forced into the sampling space 5 of the sampling valve 25, such that is filled with a sampling volume of reaction liquid 33, the sampling volume being equal to the cavity volume of the sampling space 5. The valving system 81 is then arranged in the transport configuration 87 to form the second flow path 77. The sampling valve is arranged in the transportation position 30 and the secondary fluid valve 31 is arranged in the secondary blocking position 49 (see FIG. 5G). The sampling volume of reaction liquid 33 is then transported through the sample extraction outlet to a suitable destination 75 by supply of a transportation fluid, a quench fluid and/or a dilution fluid via the transportation fluid connection 47, the quench fluid connection 89, and/or the dilution fluid connection 90, respectively. In the imaged embodiment, the transportation fluid connection 47, the quench fluid connection 89, and the dilution fluid connection 90 are integrated into a single connection. During sampling, a volume 67 in the sample channel 21 is sealed from the sampling fluid connection 35 and the secondary fluid connection 37 during the injection of sampling fluid into the reactor volume 22, such that a pressure in said volume 67 of the sample channel 21 is raised by forcing reaction liquid from the reactor volume 22 into the sample channel 21. This change in said pressure is related to the amount of sampling fluid injected into the reactor volume 22 and to the level to which the reaction liquid 33 rises in the sample channel 21. Said sealing is achieved by arranging the sampling three way valve 38 in the first sampling crossover position 46 and arranging the secondary three way valve in the secondary inline passing position, while arranging the secondary two way valve 62 in the secondary closed position 64. Alternatively, a sample blocking valve 83 arranged in the sample channel 21 between the sampling valve 25 and the sampling fluid connection 35, in particular arranged such that the buffer volume 48 is between the sampling valve 25 and the sample blocking valve 83, may be used to achieve said sealing. This sample blocking valve 83 is then arranged in a blocking position 84 during sampling and may be positioned in the blocking position 84 or in a passing position 85 during other operations, depending on whether or not flow past the sample blocking valve 83 is desired.

Prior to taking the sample, a volume of the sample channel 21, secondary fluid channel 26 and the reactor volume 22 may be depressurised by bringing them into fluid communication with the offgas area 65. Additionally or alternatively, the sample tube 21 may be cleaned by injecting a cleaning fluid into the reactor volume 22 from the sampling fluid connection 35 via the sample channel 21. Any reaction liquid 33 is thereby blown out of the sample channel 21. The cleaning fluid may be an inert gas such as nitrogen gas. The cleaning fluid is removed from the reactor volume 22 via the secondary fluid channel 26 and the secondary fluid connection 37.

Cleaning of the sample tube 21 is shown in FIG. 5B. the valving system 81 is arranged in the cleaning configuration 88. The sampling three way valve 38 is arranged in the sampling inline passing position 45. The secondary three way valve 51 is arranged in the secondary inline passing position 57. The cleaning fluid is injected into the reactor volume 22 from the sampling fluid connection 35 via the sample channel 21, thereby blowing any reaction liquid 33 out of the sample channel 21.

The sampling valve 5 is arranged above the level 24 of the reaction liquid 33 in the reactor volume 22. A buffer volume 48 is arranged in the sample channel 21, between the sampling valve 5 and the sampling fluid connection 35, in particular between the sampling valve 5 and the sampling three way valve 38. When taking the sample, the amount and/or pressure of sampling fluid injected into the reactor volume 22 is controlled to control the level 66 of the reaction liquid 33 in the buffer volume 48. This prevents the reaction liquid 33 from reaching the sampling three way valve 38, reducing the risk of contamination of or damage to the sampling three way valve 38. The volume of the buffer volume 48 is chosen such that the reaction liquid 33 completely fills the sampling valve 25 without overshooting such that it reaches the sampling three way valve 38 across a range of reaction liquid density and viscosity and volume of reaction liquid 33 in the reactor volume 22.

FIG. 5C shows a rinsing step of the sample extraction device 3. Sampling fluid is injected into the reactor volume 22 via the secondary fluid channel entrance 27, thereby raising the level 66 of reaction liquid 33 in the sample channel 21. Subsequently, fluid is removed from the reactor volume via the secondary fluid channel entrance 27, thereby lowering the level 66 of reaction liquid 33 in the sample channel 21. Repeating this multiple times rinses the sample tube 21 such that any sample taken from the reactor volume 22 comprises reaction liquid 33 from the reactor volume 22 rather than old reaction liquid 33 which may be left in the sample channel 21 from a previous sampling operation. In order to achieve this, the sampling three way valve 38 is arranged in the first sampling crossover position 46. The sampling fluid is then injected into the reactor volume 22 via the sampling fluid connection, the sampling three way valve 38 and the secondary fluid channel entrance 27 to raise the level 66 of reaction liquid 33 in the sample channel 21. Subsequently, fluid is removed from the reactor volume 22 via the sampling fluid connection 35, the sampling three way valve 38 and the secondary fluid channel entrance 27, to lower the level 66 of reaction liquid 33 in the sample channel 21.

FIGS. 5D and 5E show the sample extraction device 3 of FIG. 4A while the pressure of the sample extraction device 3 is being equalised. The sampling valve 25 is arranged in the sampling position 29 and the secondary valve 31 is arranged in the secondary flow position 50. The sampling fluid connection 35 is closed and the secondary fluid connection 37 is opened by arranging the sampling two way valve 59 in the sampling closed position 61 and arranging the secondary two way valve 62 in the secondary open position 63. The sampling three way valve 38 is arranged in the first sampling crossover position 46. The secondary three way valve 51 is alternatingly arranged in the secondary inline passing position 57 (see FIG. 4D) and the first secondary crossover position 58 (see FIG. 4E). This is repeated until the pressure in the reactor volume 22 and the sample channel 21 is sufficiently equalised with the pressure of the secondary fluid connection 37.

FIG. 5H shows an embodiment of a sample extraction device 3 according to the invention wherein, compared to the embodiment shown in FIGS. 5A-5F , the functions of the sampling three way valve 38, the secondary three way valve 51, the sampling crossover tube 43 and the secondary crossover tube 55 are taken over by the multiway valve 70. Similarly to the embodiment shown in FIGS. 5A-5F , the sample extraction device 3 comprises a sample channel 21 extending into the reactor volume 22 of the reactor 2 with a sample channel entrance 23 arranged below a liquid level 24 of a reaction liquid in the reactor volume 22 of the reactor 2. A sampling valve 25 is provided in the sampling channel 21 which is movable, for example rotatable, between a sampling position 29 and a transportation position 30. The sampling valve 25 is arranged above the liquid level 24 of the reaction liquid 33. In the sampling position 29, a sampling space 5 with a cavity volume provided in the sampling valve 25 is in fluid communication with the sample channel 21 and in the transportation position 30, the sampling space 5 is in fluid communication with the transportation fluid connection 47 and the sample extraction outlet 20. The sample extraction device 3 further comprises a secondary fluid channel 26 extending into the reactor volume 22, the secondary fluid channel 26 comprising a secondary fluid channel entrance 27 arranged in the reactor volume 22.

The sampling valve 25 is arranged between the sampling fluid connection 35 and the sample channel entrance 23, in particular between the multiway valve 70 and the sample channel entrance 23. The sampling valve comprises a sampling space 5 with a cavity volume anis is moveable to a sampling position 29 and a transportation position 30. In the sampling position 29, the sampling space is in fluid communication with the sample channel 21. In the transport position 30, the sampling space is in fluid communication with a sample extraction outlet 20 and a transportation fluid connection 47.

A secondary fluid valve 31 is arranged in the secondary fluid channel 26 between the secondary fluid connection 37 and the secondary fluid channel entrance 27, in particular between the multiway valve 70 and the secondary fluid channel entrance 27. The secondary fluid valve 31 is moveable to a secondary blocking position 49 wherein the secondary fluid valve 31 blocks flow through the secondary fluid channel 26. The secondary fluid valve 31 is also moveable to a secondary flow position 50 wherein the secondary fluid valve 31 allows flow through the secondary fluid channel 26. When extracting a sample from the reactor volume 22, the secondary fluid valve 31 is arranged in the secondary flow position 50 before sampling fluid is injected into the reactor volume 22. After the sampling space 5 is filled with a sampling volume of reaction liquid 33, the secondary fluid valve 31 is arranged in the secondary blocking position 49.

A sampling two way valve 59 is arranged in the sample channel 21, between the sampling fluid connection 35 and the sampling valve 25, in particular between the sampling fluid connection 35 and the multiway valve 70. The sampling two way valve 59 is moveable to a sampling open position 60 allowing flow past the sampling two way valve 59 and to a sampling closed position 61 not allowing flow past the sampling two way valve 59. A secondary two way valve 62 is arranged in the secondary fluid channel 26, between the secondary fluid connection 37 and the secondary fluid valve 31, in particular between the secondary fluid connection 37 and the multiway valve 70. The secondary two way valve 62 is moveable to a secondary closed position 64 wherein the secondary two way valve 62 blocks flow through the secondary fluid channel 31 and to a secondary open position 63 wherein the secondary two way valve 62 allows flow through the secondary fluid channel 26.

The multiway valve 70 is connected inline with the sample channel 21 via a first multiway 71 connection and a second multiway connection 72. The multiway valve is also connected inline with the secondary fluid channel 26 via a third multiway connection 73 and a fourth multiway connection 74. The first multiway connection 71 is arranged between the second multiway connection 72 and the sampling fluid connection 35. The second multiway connection 72 is arranged between the first multiway connection 71 and the sample channel entrance 23. The third multiway connection 73 is arranged between the fourth multiway connection 74 and the secondary fluid connection 37. The fourth multiway connection 74 is arranged between the third multiway connection 73 and the secondary fluid channel entrance 27.

The multiway valve 70 can be controlled to connect any one of the four multiway connections 71, 72, 73, 74 with one or more of the other multiway connections 71, 72, 73, 74. The multiway valve 70 can for example allow flow past the multiway valve 70 via the first multiway connection 71 and the second multiway connection 72 while closing the second multiway connection 73 and the third multiway connection 74. Alternatively, flow between the first multiway connection 71 and the second multiway connection 72 can be allowed while at the same time flow between the third multiway connection 73 and the fourth multiway connection 74 is allowed.

The multiway valve 70 can also be controlled to allow flow between other pairs of multiway connections 71, 72, 73, 74, for example between the first multiway connection 71 and the fourth multiway connection 74. This is done for example when rinsing the sample channel 21. The sampling valve 25 is preferably arranged in the sampling position 29. The secondary fluid valve 31 is arranged in the secondary flow position 50. Sampling fluid is then injected into the reactor volume via the sampling fluid connection 35, the multiway valve 70 and the secondary fluid channel entrance 27, thereby raising a level 66 of reaction liquid 33 in the sample channel 21. Subsequently, fluid is removed from the reactor volume 22 via the sampling fluid connection 35, the multiway valve 70 and the secondary fluid channel entrance 27, thereby lowering the level 66 of reaction liquid 33 in the sample channel 21. This rinses the sample channel 21 using the reaction liquid 33. If desired, the steps of raising and lowering the level 66 of reaction liquid 33 in the sample channel 21 may be repeated once or multiple times to ensure the sample channel 21 is properly rinsed. This is comparable to the situation shown in FIG. 4C for the embodiment including three way valves 38, 51 and crossover tubes 43, 55 instead of the multiway valve 70.

When taking a sample 4, the multiway valve 70 is also controlled to allow flow between the first multiway connection 71 and the fourth multiway connection 74. The sampling valve 25 is arranged in the sampling position 29. The secondary fluid connection 37 is closed. The secondary fluid valve 31 is arranged in the secondary flow position 50. Sampling fluid is then injected into the reactor volume via the sampling fluid connection 35, the multiway valve 70 and the secondary fluid channel entrance 27, thereby raising a level 66 of reaction liquid 33 in the sample channel 21 above the sampling valve 25. Reaction liquid 33 is then forced into the sampling space 5 of the sampling valve 25, such that is filled with a sampling volume of reaction liquid 33, the sampling volume being equal to the cavity volume of the sampling space 5. The sampling valve is then arranged in the transportation position 30 and the secondary fluid valve 31 is arranged in the secondary blocking position 49. The sampling volume of reaction liquid 33 is then transported through the sample extraction outlet to a suitable destination 75. During sampling, a volume 67 in the sample channel 21 is sealed from the sampling fluid connection 35 and the secondary fluid connection 37 during the injection of sampling fluid into the reactor volume 22, such that a pressure in said volume 67 of the sample channel 21 is raised by forcing reaction liquid from the reactor volume 22 into the sample channel 21. This change in said pressure is related to the amount of sampling fluid injected into the reactor volume 22 and to the level to which the reaction liquid 33 rises in the sample channel 21.

The sampling valve 5 is arranged above the level 24 of the reaction liquid 33 in the reactor volume 22. A buffer volume 48 is arranged in the sample channel 21, between the sampling valve 5 and the sampling fluid connection 35, in particular between the sampling valve 5 and the multiway valve 70. When taking the sample, the amount and/or pressure of sampling fluid injected into the reactor volume 22 is controlled to control the level 66 of the reaction liquid 33 in the buffer volume 48. This prevents the reaction liquid 33 from reaching the multi way valve 70, reducing the risk of contamination of or damage to the multi way valve 70. The volume of the buffer volume 48 is chosen such that the reaction liquid 33 completely fills the sampling valve 25 without overshooting such that it reaches the multiway valve 70 across a range of reaction liquid density and viscosity and volume of reaction liquid 33 in the reactor volume 22.

Another use of the multiway valve is when depressurising the sample extraction device 3 prior to taking a sample 4. Here, the sampling fluid connection 35 is closed, for example by stopping the supply of sampling fluid or by arranging the sampling two way valve 59 in the sampling closed position 61. The multiway valve 70 is controlled to allow fluid flow between the second multiway connection 72, the third multiway connection 73 and the fourth multiway connection 74. This equalised the pressure in the sample channel 21 and the secondary fluid channel 26. Preferably, the secondary two way valve 62 is in the secondary open position 63, such that the pressure in the sample channel 21 and the secondary fluid channel 26 is equalised to the pressure of the offgas area 65. The sampling valve 25 is arranged in the sampling position 29 and the secondary fluid valve 31 is arranged in the secondary flow position 50 such that the pressure in the reactor volume 22 is also equalised. This is comparable to the situation shown in FIG. 4C for the embodiment including three way valves 38, 51 and crossover tubes 43, 55 instead of the multiway valve 70. Alternatively, instead of allowing fluid flow between the second multiway connection 72, the third multiway connection 73 and the fourth multiway connection 74 simultaneously, the multiway valve 70 may be controlled to alternatingly allow fluid flow between the third multiway connection 73 and the fourth multiway connection 74 or the second multiway connection 72 and the third multiway connection 73. This is comparable to the situation shown in FIGS. 5D and 5E for the embodiment including three way valves 38, 51 and crossover tubes 43, 55 instead of the multiway valve 70.

Before or after taking a sample, or at any other opportune moment, the sample tube 21 may be cleaned by blowing a cleaning fluid such as nitrogen gas through it. The cleaning fluid may be the same fluid as the sample fluid. This may be performed by arranging the multiway valve 70 to allow fluid flow between the first multiway connection 71 and the second multiway connection 72 and between the third multiway connection 73 and the fourth multiway connection 74. The cleaning fluid is then injected into the reactor volume 22 from the sampling fluid connection 35 via the sample channel 21, thereby blowing any reaction liquid 33 out of the sample channel 21. The cleaning fluid bubbles up through the reaction liquid 33 and is removed from the reactor volume 22 via the secondary fluid channel 26 and the secondary fluid connection 37.

In the embodiments shown in FIGS. 4A-4F , the embodiment shown in FIGS. 5A-5G and in the embodiment shown in 5H, the secondary fluid channel entrance arranged above liquid level of reaction liquid in the reactor.

The sample extraction device of the embodiments shown in FIGS. 4A-4F , the embodiment shown in FIGS. 5A-5G and the embodiment shown in 5H may be in incorporated in a cap which can be attached to standard format reactor vessels and the reactor-cap combination can be “clicked” into ports on the system chassis without external tubing (which would otherwise interfere with human or robotic ergonomics).

The different method steps described for the embodiments shown in FIG. 4A 4F, the embodiment shown in FIGS. 5A-5G and the embodiment shown in 5H may be combined to further advantage.

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting, but rather, to provide an understandable description of the invention.

This patent application furthermore relates to the following clauses:
1. Sample extraction device configured for extracting a sample from a reactor, the sample extraction device comprising:
a sample channel configured to extend into a reactor volume of the reactor, the sample channel comprising a sample channel entrance configured to be arranged below a liquid level of a reaction liquid in the reactor volume,
a secondary fluid channel configured to extend into the reactor volume, the secondary fluid channel comprising a secondary fluid channel entrance configured to be in fluid communication with the reactor volume,
a sampling fluid connection connected to the sample channel, configured to provide a pressurised sampling fluid to the sampling fluid connection, wherein the sampling fluid is preferably an inert gas such as nitrogen gas,
a secondary fluid connection connected to the secondary fluid channel,
a sampling three way valve arranged in the sample channel, the sampling three way valve comprising a first sampling connection, a second sampling connection and a third sampling connection, wherein the first sampling connection and the second sampling connection are connected inline with the sample channel and wherein the third sampling connection is connected to a sampling crossover tube which is connected with the secondary fluid channel at a secondary crossover connection, wherein the first sampling connection is arranged between the second sampling connection and the sampling fluid connection and the second sampling connection is arranged between the first sampling connection and the sample channel entrance,
   wherein:
the sampling three way valve is arranged between the sampling fluid connection and the sample channel entrance,
the sampling three way valve is movable to a sampling inline passing position wherein fluid flow is allowed between the first sampling connection and the second sampling connection and wherein no fluid flow is allowed through the third sampling connection,
the sampling three way valve is movable to a first sampling crossover position wherein fluid flow is allowed between the first sampling connection and the third sampling connection and wherein no fluid flow is allowed through the second sampling connection.
2. Sample extraction device according to clause 1, comprising:
a sampling valve arranged in the sample channel,
a sample extraction outlet,
   wherein:
the sampling valve is arranged between the sampling fluid connection and the sample channel entrance, wherein the sampling valve is preferably arranged between the sampling three way valve and the sample channel entrance,
the sampling valve comprises a sampling space with a cavity volume,
the sampling valve is movable to a sampling position and to a transportation position,
the sampling space is in fluid communication with the sample channel in the sampling position of the sampling valve,
the sampling space is in fluid communication with the sample extraction outlet in the transportation position of the sampling valve.
3. Sample extraction device according to the preceding clause, comprising:
a transportation fluid connection for providing a transportation fluid, wherein optionally the transportation fluid is an inert gas, preferably nitrogen gas,
in the transportation position of the sampling valve, the sampling space is in fluid communication with the transportation fluid connection in the transportation position of the sampling valve.
4. Sample extraction device according to clause 2 or 3, wherein the sampling valve is configured to be arranged above the liquid level of the reaction liquid in the reactor volume.

5. Sampling extraction device according to any of clauses 2-4, wherein the sample channel comprises a buffer volume arranged between the sampling valve and the sampling fluid connection, wherein the buffer volume is preferably arranged between the sampling valve and the sampling three way valve.

6. Sample extraction device according to any of the preceding clauses, comprising:
a secondary fluid valve arranged in the secondary fluid channel and between the secondary fluid connection and the secondary fluid channel entrance, wherein the secondary fluid valve is preferably arranged between the secondary crossover connection and the secondary fluid channel entrance,
   wherein:
the secondary fluid valve is moveable to a secondary blocking position wherein the secondary fluid valve blocks flow through the secondary fluid channel and the secondary fluid valve is moveable to a secondary flow position wherein the secondary fluid valve allows flow through the secondary fluid channel.
7. Sample extraction device according to any of the preceding clauses, comprising:
a secondary three way valve arranged in the secondary fluid channel, the secondary three way valve comprising a first secondary connection, a second secondary connection and a third secondary connection, wherein the first secondary connection and the second secondary connection are connected inline with the secondary fluid channel and wherein the third secondary connection is connected to a secondary crossover tube which is connected with the sample channel at a sampling crossover connection, wherein the first secondary fluid connection is arranged between the second secondary fluid connection and the secondary fluid connection and the second secondary fluid connection is arranged between the first secondary fluid connection and the secondary fluid channel entrance,
   wherein:
the secondary three way valve is arranged between the secondary fluid connection and the secondary fluid channel entrance, wherein the secondary three way valve is preferably arranged between the secondary fluid connection and the secondary crossover connection,
the secondary three way valve is movable to a secondary inline passing position wherein fluid flow is allowed between the first secondary connection and the second secondary connection and wherein no fluid flow is allowed through the third secondary connection,
the secondary three way valve is movable to a first secondary crossover position wherein fluid flow is allowed between the first secondary connection and the third secondary connection and wherein no fluid flow is allowed through the second secondary connection.
8. Sample extraction device according to the preceding clause, further comprising the features of clause 8, wherein:
the secondary crossover connection is arranged between the secondary three way valve and the secondary fluid valve.
9. Sample extraction device according to clause 7 or 8, the sample extraction device further comprising the features of clause 2, wherein:
the sampling crossover connection is arranged between the sampling three way valve and the sampling valve.
10. Sample extraction device according to any of the preceding clauses, the sample extraction device further comprising:
a sampling two way valve arranged in the sample channel between the sampling fluid connection and the sampling three way valve, wherein the sampling two way valve is movable to a sampling open position allowing flow past the sampling two way valve and a sampling closed position not allowing flow past the sampling two way valve, AND/OR
the features of clause 8 and a secondary two way valve arranged in the secondary fluid channel between the secondary fluid connection and the secondary three way valve, wherein the secondary two way valve is movable to a secondary open position allowing flow past the secondary two way valve and a secondary closed position not allowing flow past the secondary two way valve.
11. Method of sampling a reaction liquid from a reactor using a sample extraction device, the sample extraction device comprising:
a sample channel configured to extend into a reactor volume of the reactor, the sample channel comprising a sample channel entrance configured to be arranged below a liquid level of a reaction liquid in the reactor volume,
a secondary fluid channel configured to extend into the reactor volume, the secondary fluid channel comprising a secondary fluid channel entrance configured to be in fluid communication with the reactor volume,
a sampling fluid connection connected to the sample channel, configured to provide a pressurised sampling fluid to the sampling fluid connection, wherein the sampling fluid is preferably an inert gas such as nitrogen gas,
a secondary fluid connection connected to the secondary fluid channel,
   wherein the method comprises the steps of:
depressurising a volume in the sample channel, a volume in the secondary fluid channel and the reactor volume by bringing the sample channel and the secondary fluid channel in fluid communication with an offgas area such as the atmosphere,
drawing a sample into the sample channel by injecting sampling fluid into the reactor via the secondary fluid channel entrance while sealing a volume of the sample channel from the sampling fluid connection and the secondary fluid connection, thereby raising a level of reaction liquid in the sample channel, and raising a pressure in said volume of the sample channel,
extracting the sample from the sample channel and moving it to a suitable destination.
12. Method according to the preceding clause, wherein the method comprises the steps of:
injecting a cleaning fluid into the reactor volume from the sampling fluid connection via the sample channel, thereby blowing any reaction liquid out of the sample channel, wherein optionally the cleaning fluid is an inert gas such as nitrogen gas,
removing the cleaning fluid from the reactor volume via the secondary fluid channel and the secondary fluid connection,
   wherein said steps are preferably performed before depressurising and drawing a sample.
13. Method according to any of the preceding method clauses, wherein the method comprises the steps of:
injecting sampling fluid into the reactor volume via the secondary fluid channel entrance, thereby raising a level of reaction liquid in the sample channel,
subsequently removing fluid from the reactor volume via the secondary fluid channel entrance, thereby lowering the level of reaction liquid in the sample channel,
   wherein said steps are preferably performed before depressurising and drawing a sample.
14. Method of rinsing a sample extraction device according to any of the preceding device clauses, the method comprising the steps of:
arranging the sampling three way valve in the first sampling crossover position,
injecting sampling fluid into the reactor volume via the sampling fluid connection, the sampling three way valve and the secondary fluid channel entrance, thereby raising a level of reaction liquid in the sample channel,
subsequently removing fluid from the reactor volume via the sampling fluid connection, the sampling three way valve and the secondary fluid channel entrance, thereby lowering the level of reaction liquid in the sample channel.
15. Method of depressurizing a sample extraction device according to clause 8 or 9, the method comprising the steps of:
closing the sampling fluid connection and opening the secondary fluid connection,
arranging the sampling three way valve in the first sampling crossover position,
alternatingly arranging the secondary three way valve in the secondary inline passing position and the first secondary crossover position multiple times to equalise the pressure in both the reactor volume and the sample channel with the pressure of the secondary fluid connection.
16. Method according to the preceding clause, wherein the step of depressurising the sample extraction device is performed prior to taking a sample from the reactor.
17. Method according to clause 15 or 16, the sample extraction device comprising the features of clause 2, the method comprising the step of arranging the sampling valve in the sampling position.
18. Method according to any of clauses 15-17, the sample extraction device comprising the features of clause 7, the method comprising the step of arranging the secondary fluid valve in the secondary flow position.
19. Method of sampling a reaction liquid from a reactor using a sample extraction device according to any of clauses 2-4, the method comprising the steps of:
arranging the sampling three way valve in the first sampling crossover position,
arranging the sampling valve in the sampling position,
closing the secondary fluid connection,
injecting sampling fluid into the reactor volume via the sampling fluid connection, the sampling three way valve and the secondary fluid channel entrance, thereby forcing reaction fluid from the reactor volume into the sample channel and into the sampling space, thereby filling the sampling space with a sampling volume of reaction liquid, the sampling volume being equal to the cavity volume,
subsequently arranging the sampling valve in the transportation position,
transporting the sampling volume of reaction liquid from the sampling space through the sample extraction outlet to a suitable destination.
20. Method of sampling a reaction liquid from a reactor according to the preceding clause, wherein a volume in the sample channel is sealed from the sampling fluid connection and the secondary fluid connection during the injection of sampling fluid into the reactor volume, such that a pressure in said volume of the sample channel is raised by forcing reaction fluid from the reactor volume into the sample channel.

21. Method of sampling a reaction liquid from a reactor using a sample extraction device according to clause 6, the method comprising the steps of:
arranging the sampling three way valve in the first sampling crossover position,
injecting sampling fluid into the reactor volume via the sampling fluid connection, the sampling three way valve and the secondary fluid channel entrance, thereby forcing reaction fluid from the reactor volume into the sample channel into and past the sampling valve and into the buffer volume,
regulating an amount and/or pressure of sampling fluid injected into the reactor volume to control a level of the reaction fluid in the buffer volume.
22. Method of sampling a reaction liquid according to the preceding clause, the method comprising the step of:
preventing the reaction fluid forced into the sample channel from reaching the sampling three way valve by regulating an amount and/or pressure of sampling fluid injected into the reactor volume to control a level of the reaction fluid in the buffer volume.
23. Method of sampling a reaction liquid from a reactor using a sample extraction device comprising the features of clause 7, the method comprising performing the step of:
arranging the secondary fluid valve in the secondary flow position, before injecting sampling fluid into the reactor volume.
24. Method of sampling a reaction liquid from a reactor according to the preceding clause, the method further comprising the features of clause 16, the method comprising the step of:
arranging the secondary fluid valve in the secondary blocking position after filling the sampling space with a sampling volume of reaction liquid.
25. Method of sampling a reaction liquid from a reactor using a sample extraction device according to any of the preceding device clauses, the method comprising the steps of, prior to taking the sample from the reactor:
arranging the sampling three way valve in the sampling inline passing position,
arranging the secondary three way valve in the secondary inline passing position,
injecting a cleaning fluid into the reactor volume from the sampling fluid connection via the sample channel, thereby blowing any reaction liquid out of the sample channel, wherein optionally the cleaning fluid is an inert gas such as nitrogen gas,
removing the cleaning fluid from the reactor volume via the secondary fluid channel and the secondary fluid connection.
26. Method of sampling a reaction liquid combining the steps of at least two of the preceding method clauses.
27. Sample extraction device configured for extracting a sample from a reactor, the sample extraction device comprising:
a sample channel configured to extend into a reactor volume of the reactor, the sample channel comprising a sample channel entrance configured to be arranged below a liquid level of a reaction liquid in the reactor volume,
a secondary fluid channel configured to extend into the reactor volume, the secondary fluid channel comprising a secondary fluid channel entrance configured to be in fluid communication with the reactor volume,
a sampling fluid connection connected to the sample channel, configured to provide a pressurised sampling fluid to the sampling fluid connection, wherein the sampling fluid is preferably an inert gas such as nitrogen gas,
a secondary fluid connection connected to the secondary fluid channel,
a multiway valve, wherein the multiway valve is connected inline with the sample channel via a first multiway connection and a second multiway connection, wherein the multiway valve is connected inline with the secondary fluid channel via a third multiway connection and a fourth multiway connection,
   wherein:
the first multiway connection is arranged between the second multiway connection and the sampling fluid connection, the second multiway connection is arranged between the first multiway connection and the sample channel entrance, the third multiway connection is arranged between the fourth multiway connection and the secondary fluid connection, the fourth multiway connection is arranged between the third multiway connection and the secondary fluid channel entrance,
the multiway valve is configurable to connect any one of the four multiway connections with one or more of the other multiway connections.
28. Sample extraction device according to the preceding clause, comprising:
a sampling valve arranged in the sample channel,
a sample extraction outlet,
   wherein:
the sampling valve is arranged between the sampling fluid connection and the sample channel entrance, wherein the sampling valve is preferably arranged between the multiway valve and the sample channel entrance,
the sampling valve comprises a sampling space with a cavity volume,
the sampling valve is movable to a sampling position and to a transportation position,
the sampling space is in fluid communication with the sample channel in the sampling position of the sampling valve,
the sampling space is in fluid communication with the sample extraction outlet in the transportation position of the sampling valve.
29. Sample extraction device according to the preceding clause, comprising:
a transportation fluid connection for providing a transportation fluid, wherein optionally the transportation fluid is an inert gas, preferably nitrogen gas,
in the transportation position of the sampling valve, the sampling space is in fluid communication with the transportation fluid connection in the transportation position of the sampling valve.
30. Sample extraction device according to clause 28 or 29, wherein the sampling valve is configured to be arranged above the liquid level of the reaction liquid in the reactor volume.

31 Sampling extraction device according to any of clauses 28-30, wherein the sample channel comprises a buffer volume arranged between the sampling valve and the sampling fluid connection, wherein the buffer volume is preferably arranged between the sampling valve and the multiway valve.

32. Sample extraction device according to any of clauses 27-31, comprising:
a secondary fluid valve arranged in the secondary fluid channel and between the secondary fluid connection and the secondary fluid channel entrance, wherein the secondary fluid valve is preferably arranged between the multiway valve and the secondary fluid channel entrance,
   wherein:
the secondary fluid valve is moveable to a secondary blocking position wherein the secondary fluid valve blocks flow through the secondary fluid channel and the secondary fluid valve is moveable to a secondary flow position wherein the secondary fluid valve allows flow through the secondary fluid channel.
33. Sample extraction device according to any of clauses 27-32, the sample extraction device further comprising:
a sampling two way valve arranged in the sample channel between the sampling fluid connection and the sampling valve, wherein the sampling two way valve is movable to a sampling open position allowing flow past the sampling two way valve and a sampling closed position not allowing flow past the sampling two way valve, AND/OR
a secondary two way valve arranged in the secondary fluid channel between the secondary fluid connection and the secondary fluid valve, wherein the secondary two way valve is movable to a secondary open position allowing flow past the secondary two way valve and a secondary closed position not allowing flow past the secondary two way valve.
34. Method of rinsing a sample extraction device according to any of clauses 27-33, the method comprising the steps of:
arranging the multiway valve to allow fluid flow between the first multiway connection and the fourth multiway connection and to block fluid flow through the second multiway connection,
injecting sampling fluid into the reactor volume via the sampling fluid connection, the multiway valve and the secondary fluid channel entrance, thereby raising a level of reaction liquid in the sample channel,
subsequently removing fluid from the reactor volume via the sampling fluid connection, the multiway valve and the secondary fluid channel entrance, thereby lowering the level of reaction liquid in the sample channel.
35. Method of depressurizing a sample extraction device according to any of clauses 27-33, the method comprising the steps of:
closing the sampling fluid connection and opening the secondary fluid connection,
arranging the multiway valve to allow fluid flow between the second multiway connection, the third multiway connection and the fourth multiway connection, or alternatively alternatingly arranging the multiway valve to:
allow fluid flow between the third multiway connection and the fourth multiway connection, and to
allow fluid flow between the second multiway connection and the third multiway connection,
36. Method according to the preceding clause, wherein the step of depressurising the sample extraction device is performed prior to taking a sample from the reactor.
37. Method according to clause 35 or 36, the sample extraction device comprising the features of clause 28, the method comprising the step of arranging the sampling valve in the sampling position.
38. Method according to any of clauses 35-37, the sample extraction device comprising the features of clause 32, the method comprising the step of arranging the secondary fluid valve in the secondary flow position.
39 Method of sampling a reaction liquid from a reactor using a sample extraction device according to clause 28 or 29, the method comprising the steps of:
arranging the multiway valve to allow fluid communication between the first multiway connection and the fourth multiway connection,
arranging the sampling valve in the sampling position,
closing the secondary fluid connection,
injecting sampling fluid into the reactor volume via the sampling fluid connection, the multiway valve and the secondary fluid channel entrance, thereby forcing reaction fluid from the reactor volume into the sample channel and into the sampling space, thereby filling the sampling space with a sampling volume of reaction liquid, the sampling volume being equal to the cavity volume,
subsequently arranging the sampling valve in the transportation position,
transporting the sampling volume of reaction liquid from the sampling space through the sample extraction outlet to a suitable destination.
40. Method of sampling a reaction liquid from a reactor according to the preceding clause, wherein a volume in the sample channel is sealed from the sampling fluid connection and the secondary fluid connection during the injection of sampling fluid into the reactor volume, such that a pressure in said volume of the sample channel is raised by forcing reaction fluid from the reactor volume into the sample channel.
41 Method of sampling a reaction liquid from a reactor using a sample extraction device according to clause 31, the method comprising the steps of:
arranging the multiway valve to allow fluid communication between the first multiway connection and the fourth multiway connection,
injecting sampling fluid into the reactor volume via the sampling fluid connection, the multiway valve and the secondary fluid channel entrance, thereby forcing reaction fluid from the reactor volume into the sample channel into and past the sampling valve and into the buffer volume,
regulating an amount and/or pressure of sampling fluid injected into the reactor volume to control a level of the reaction fluid in the buffer volume.
42. Method of sampling a reaction liquid according to the preceding clause, the method comprising the step of:
preventing the reaction fluid forced into the sample channel from reaching the multi way valve by regulating an amount and/or pressure of sampling fluid injected into the reactor volume to control a level of the reaction fluid in the buffer volume.
43. Method of sampling a reaction liquid from a reactor using a sample extraction device comprising the features of clause 32, the method comprising performing the step of:
arranging the secondary fluid valve in the secondary flow position, before injecting sampling fluid into the reactor volume.
44. Method of sampling a reaction liquid from a reactor according to the preceding clause, the method further comprising the features of clause 36, the method comprising the step of:
arranging the secondary fluid valve in the secondary blocking position after filling the sampling space with a sampling volume of reaction liquid.
45 Method of sampling a reaction liquid from a reactor using a sample extraction device according to any clauses 27-33, the method comprising the steps of, prior to taking the sample from the reactor:
arranging the multiway valve to allow fluid flow between the first multiway connection and the second multiway connection and between the third multiway connection and the fourth multiway connection,
injecting a cleaning fluid into the reactor volume from the sampling fluid connection via the sample channel, thereby blowing any reaction liquid out of the sample channel, wherein optionally the cleaning fluid is an inert gas such as nitrogen gas,
removing the cleaning fluid from the reactor volume via the secondary fluid channel and the secondary fluid connection.
46 Method of sampling a reaction liquid combining the steps of at least two of method clauses 28-45.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language, not excluding other elements or steps). Any reference signs in the claims should not be construed as limiting the scope of the claims or the invention.

The term “liquid” as used herein includes any type of mixture exhibiting liquid-like properties, such as slurries, gels, solid-liquid mixtures etcetera.

The mere fact that certain measures are recited in mutually different dependent claims or clauses does not indicate that a combination of these measures cannot be used to advantage.

1. A method of sampling a reaction liquid from a reactor, wherein the method comprises the steps of:
providing a sample extraction device comprising the features of claim 11,
bringing the sampling fluid connection in fluid communication with the secondary fluid channel entrance to form a first flow path extending from the sampling fluid connection to the secondary fluid channel entrance and drawing a sample into the sample channel by injecting sampling fluid into the reactor via the first flow path and the secondary fluid channel entrance while sealing the buffer volume of the sample channel from the secondary fluid connection and the offgas connection, thereby raising a level of reaction liquid in the sample channel, and raising a pressure in said buffer volume of the sample channel, and
bringing the secondary fluid connection in fluid communication with the sample extraction outlet, thereby forming a second flow path extending from the secondary fluid connection to the sample extraction outlet and subsequently feeding a secondary fluid to the secondary fluid connection, thereby extracting the sample from the sample channel and moving it to a suitable destination.

2. The method according to claim 1, wherein the method comprises the steps of:
depressurising a volume in the sample channel, a volume in the secondary fluid channel and the reactor volume by arranging the valving system to bring the sample channel and the secondary fluid channel in fluid communication with the offgas connection, thereby forming a third flow path extending from the secondary fluid channel entrance to the offgas connection and a fourth flow path extending from the sample channel entrance to the offgas connection.

3. The method according to claim 2, wherein the sample extraction device further comprises:
wherein the valving system is arrangeable in a depressurising configuration, wherein in the depressurising configuration:
the sampling valve is in the sampling position,
the secondary fluid channel entrance is in fluid communication with the offgas connection, and
the sample channel entrance is in fluid communication with the offgas connection, and
wherein the step of depressurising comprises arranging the valving system in the depressurising configuration.

4. The method according to claim 1, wherein the method comprises the steps of cleaning the sample extraction device by:
injecting a cleaning fluid into the reactor volume from the sampling fluid connection via the sample channel, thereby blowing any reaction liquid out of the sample channel, wherein optionally the cleaning fluid is an inert gas such as nitrogen gas, and
removing the cleaning fluid from the reactor volume via the secondary fluid channel and the secondary fluid connection,
wherein said steps of cleaning the sample extraction device are preferably performed before drawing a sample.

5. The method according to claim 4, wherein the sample extraction device further comprises:
a cleaning fluid connection, wherein the valving system is arrangeable in a cleaning configuration, wherein optionally the cleaning fluid connection is the sampling fluid connection, wherein in the cleaning configuration:
a cleaning fluid connection is in fluid communication with the sample channel entrance, and
the secondary fluid channel entrance is in fluid communication with the offgas connection, and
wherein the steps of cleaning the sample extraction device comprise arranging the valving system in the cleaning configuration.

6. The method according to claim 1, wherein the method comprises rinsing the sampling tube by performing the steps of:
injecting sampling fluid into the reactor volume via the secondary fluid channel entrance, thereby raising a level of reaction liquid in the sample channel,
subsequently removing fluid from the reactor volume via the secondary fluid channel entrance, thereby lowering the level of reaction liquid in the sample channel, and
optionally repeating the steps of injecting and removing sampling fluid via the secondary fluid channel entrance,
wherein said steps are preferably performed before depressurising and drawing a sample.

7. The method according to claim 1,
wherein the sample extraction device further comprises:
wherein the valving system is arrangeable in a sampling configuration, wherein in the sampling configuration:
the sampling valve is in the sampling position,
the secondary fluid channel entrance is in fluid communication with the sampling fluid connection,
the sample channel entrance is not in fluid communication with the offgas connection, and
wherein the step of drawing the sample comprises arranging the valving system in the sampling configuration.

8. The method according to claim 1, wherein the step of drawing the sample comprises the steps of:
injecting sampling fluid into the reactor volume via the sampling fluid connection, the valving system and the secondary fluid channel entrance, thereby forcing reaction liquid from the reactor volume into the sample channel into and past the sampling valve and into the buffer volume of the sample channel, and
regulating an amount and/or pressure of sampling fluid injected into the reactor volume to control a level of the reaction liquid in the buffer volume.

9. The method according to claim 1,
wherein the sample extraction device further comprises:
wherein the valving system is arrangeable in a transport configuration, wherein in the transport configuration:
the sampling valve is in the transportation position,
the secondary fluid connection is in fluid communication with the sampling space, and
wherein the step of extracting the sample and moving it to a suitable location comprises arranging the valving system in the transport configuration.

10. The method according to claim 1, wherein the secondary fluid comprises a quench fluid and/or a dilution fluid and/or a transportation fluid, the transportation fluid preferably being an inert gas such as nitrogen gas.

11. A sample extraction device configured for extracting a sample from a reactor, the sample extraction device comprising:
a sample channel configured to extend into a reactor volume of the reactor, the sample channel comprising a sample channel entrance configured to be arranged below a liquid level of a reaction liquid in the reactor volume,
a secondary fluid channel configured to extend into the reactor volume, the secondary fluid channel comprising a secondary fluid channel entrance configured to be in fluid communication with the reactor volume,
a sampling fluid connection connected to the sample channel, configured to provide a pressurised sampling fluid to sample extraction device via the sampling fluid connection, wherein the sampling fluid is preferably an inert gas such as nitrogen gas,
a secondary fluid connection,
a sample extraction outlet,
an offgas connection,
a buffer volume arranged between the sampling valve and the sampling fluid connection,
a valving system connected to the sample channel, the secondary fluid channel, the sampling fluid connection, the secondary fluid connection, the sample extraction outlet, and the offgas connection,
the valving system comprising a sampling valve,
wherein:
the sampling valve is arranged between the sampling fluid connection and the sample channel entrance,
the sampling valve comprises a sampling space with a cavity volume,
the sampling valve is movable to a sampling position and to a transportation position,
the sampling space is in fluid communication with the sample channel in the sampling position of the sampling valve, and
the sampling space is in fluid communication with the sample extraction outlet in the transportation position of the sampling valve.

12. The sample extraction device according to claim 11, wherein the valving system is arrangeable in a sampling configuration, wherein in the sampling configuration:
the sampling valve is in the sampling position,
the secondary fluid channel entrance is in fluid communication with the sampling fluid connection, and
the sample channel entrance is not in fluid communication with the offgas connection.

13. The sample extraction device according to claim 12, wherein the valving system comprises a sample blocking valve arranged in the sample channel between the sampling valve and the sampling fluid connection, wherein the sample blocking valve is arranged in a blocking position in the sampling configuration of the valving system.

14. The sample extraction device according to claim 13, wherein the buffer volume is arranged between the sampling valve and the sample blocking valve.

15. The sample extraction device according to claim 11, wherein the valving system is arrangeable in a depressurising configuration, wherein in the depressurising configuration:
the sampling valve is in the sampling position,
the secondary fluid channel entrance is in fluid communication with the offgas connection, and
the sample channel entrance is in fluid communication with the offgas connection.

16. The sample extraction device according to claim 11, wherein the valving system is arrangeable in a transport configuration, wherein in the transport configuration:
the sampling valve is in the transportation position, and
the secondary fluid connection is in fluid communication with the sampling space.

17. The sample extraction device according to claim 16, wherein in the transport configuration:
the sample extraction outlet is in fluid communication with the secondary fluid connection, AND/OR
the sample channel entrance is not in fluid communication with the sampling fluid connection.

18. The sample extraction device according to claim 16, wherein:
the secondary fluid connection comprises a transportation fluid connection for providing a transportation fluid, wherein optionally the transportation fluid is an inert gas, preferably nitrogen gas,
in the transportation position of the sampling valve, the sampling space is in fluid communication with the transportation fluid connection.

19. The sample extraction device according to claim 11, the sample extraction device comprising a cleaning fluid connection, wherein the valving system is arrangeable in a cleaning configuration, wherein optionally the cleaning fluid connection is the sampling fluid connection, wherein in the cleaning configuration:
a cleaning fluid connection is in fluid communication with the sample channel entrance, and
the secondary fluid channel entrance is in fluid communication with the offgas connection.

20. The sample extraction device according to claim 11, wherein:
the secondary fluid connection comprises a quench fluid connection for providing a quench fluid, and
in the transportation position of the sampling valve, the sampling space is in fluid communication with the quench fluid connection.

21. The sample extraction device according to claim 11, wherein:
the secondary fluid connection comprises a dilute fluid connection for providing a dilute fluid, and
in the transportation position of the sampling valve, the sampling space is in fluid communication with the dilute fluid connection.

22. The sample extraction device according to claim 11, wherein the sampling valve is configured to be arranged above the liquid level of the reaction liquid in the reactor volume.

23. The sample extraction device according to claim 11, wherein the valving system comprises:
a secondary fluid valve arranged in the secondary fluid channel and between the secondary fluid connection and the secondary fluid channel entrance,
wherein:
the secondary fluid valve is moveable to a secondary blocking position wherein the secondary fluid valve blocks flow through the secondary fluid channel such that flow through the secondary fluid channel entrance is blocked and the secondary fluid valve is moveable to a secondary flow position wherein the secondary fluid valve allows flow through the secondary fluid channel and allows flow through the secondary fluid channel entrance.
